(19) United States
(12) Patent Application Publication
(10) Pub. No.: US 2003/0198345 A1
(43) Pub. Date: Oct. 23, 2003

(54) Method and apparatus for high speed implementation of data encryption and decryption utilizing, e.g. Rijndael or its subset AES, or other encryption/decryption algorithms having similar key expansion data flow

(76) Inventor: Darrel J. Van Buer, Los Angeles, CA (US)

Correspondence Address: William C. Cray, Suite A, 414 Fourth Street, Santa Ana, CA, 92701, US

(21) Appl. No.: 10/040,087

(22) Filed: Apr. 15, 2002

(51) Int. Cl. H04K 1/00

(52) U.S. Cl. 380/43

(57) ABSTRACT

An encryption/decryption method and apparatus may comprise performing in series stages of encryption/decryption operations on a stage data block of a first selected width utilizing an encryption/decryption key of the first selected width and providing an output data block of the first selected width, comprising a subsequent stage input data block input to a subsequent stage of the series of stages; holding the stage input data block for input into a stage of the series of stages, the input data block having the first selected width; encrypting the stage input data block into a encrypted stage input data block having the first selected width, the encrypted stage input data block comprising a unique combination of data bits for each unique combination of data bits in the stage input data block of the first selected width; decrypting the stage input data block into a decrypted stage input data block having the first selected width, the decrypted stage input data block comprising a unique combination of data bits for each unique combination of data bits in the stage input data block of the first selected width that is the inverse of the encryption performed by the encryption step; performing a substitution operation on either the encrypted stage input data block or the decrypted stage input data block. A subsequent stage input data block may be the subsequent stage of the series of stages the output of the substitution step or the stage input data block. One may perform in series the stages of the encryption/decryption operations in a first plurality of stages of the series of stages, each comprising a round, and repeat this operation a selected number of times and a selected number of rounds each of the selected number of times, to thereby effect a total number of rounds. One may perform in any given one of the first plurality of times less than the first plurality of rounds depending upon the total number of rounds necessary. One may generate each round key by the expansion of a starting key of a second selected width. The second selected width may equal the first selected width; and, the encryption step may further include performing an affine transformation and the decryption step may further include performing an inverse of the affine transformation.

### RELATED APPLICATIONS

The present application is related to the contemporaneously filed application, assigned to the assignee of the present application Ser. No. ______, Attorney Docket 1044-405-01, entitled Method and Apparatus for High Speed Key Expansion in a Parallel Pipelined Implementation of, e.g., Rijndael or Its Subset AES, or Other Encryption Algorithms with Similar Key Data Flow, the disclosure of which is hereby incorporated by reference.

### FIELD OF THE INVENTION

The present invention relates to the field of high-speed data encryption and decryption utilizing Rijndael or its subset AES implemented in integrated circuit hardware, and specifically in a pipelined architecture.

### BACKGROUND OF THE INVENTION

The Advanced Encryption Standard (AES) specification, Federal Information processing Standards Publication (FIPS Publication) ZZZ, NIST XX, 2001, (“the FIPS AES Standard”), the disclosure of which is hereby incorporated by reference, is scheduled for adoption as a US FIPS standard in 2001. The published specification defines the input/output behavior of a correct implementation. AES has selected a version of the Rijndael algorithm, J. Daemen, et al., AES Proposal Rijndael, Version 2, Mar. 2, 1999, (“Rijndael Proposal”), the disclosure of which is hereby incorporated by reference. The selection of Rijndael for AES included evaluation of its suitability for implementation in both hardware and software. While the specification clearly avoids many design choices that would be obstacles to fast software or simple hardware, it does not provide much guidance toward a fast or efficient implementation.

The prior art addresses some general approaches to fast implementation such as unrolling loops into simultaneous parallel units or pipeline stages. The primary disadvantage of older encryption systems like DES (FIPS 46-3), the disclosure of which is hereby incorporated by reference, with its 56-bit key is that their security has been substantially weakened by the considerable improvements in computer performance since its introduction in 1977. The primary advantages AES has over the alternatives now available are related to the evaluation process and its forthcoming standardization. All of the candidates for AES were subject to considerable scrutiny into potential performance, implementation ability and good cryptographic strength. While other cryptographic systems remain important in areas of very high security, public key systems or very low implementation cost, AES represents a very good compromise between competing requirements.

Because of the complexity of the AES algorithm, there are a large number of design choices and tradeoffs that can be made to realize a fast and efficient hardware implementation. The formal description of the multiply operation shows that the only operations needed are XOR and shift but does not expand on the implications for composing and minimizing gate complexity. This disclosure describes a way to achieve a high-performance implementation of the AES block cipher algorithm while also limiting the complexity of the required hardware.

The inputs to AES consist of a binary key and a binary block of data. Both the key and the data may be 128, 192 or 256 bits long in the original Rijndael design, and need not be the same length. The first proposed FIPS standard for AES simplifies this slightly by limiting the data block size to 128 bits only. Future versions of the standard, however, might restore or extend some of these parameters. The output is another block of binary data the same length as the input data. This output and the same key can be used to reconstruct the original data block, essentially by performing the same steps, but in inverse and in some implementations in reverse order. While AES allows several key lengths, it would be possible to implement subsets of the valid sizes. For example, an implementation supporting only 128 bit keys and 128 bit data blocks might be easier to license for export. Implementations for fixed sizes are less complex to implement because in many cases multiplexing can be simplified or eliminated, increasing speed marginally as well. The overall design of AES is to compose a series of identically structured transformations on a block of data to be encrypted or decrypted. Each transformation is called a round. Within a single round, several different transformations are performed in series to scramble the bits in a block of data. The total number of rounds employed is a function of the key and data length.

### SUMMARY OF THE INVENTION

An encryption/decryption method and apparatus is disclosed which may comprise performing in series stages of encryption/decryption operations on a stage data block of a first selected width utilizing an encryption/decryption key of the first selected width and providing an output data block of the first selected width, comprising a subsequent stage input data block input to a subsequent stage of the series of stages; holding the stage input data block for input into a stage of the series of stages, the input data block having the first selected width; encrypting the stage input data block into a encrypted stage input data block having the first selected width, the encrypted stage input data block comprising a unique combination of data bits for each unique combination of data bits in the stage input data block of the first selected width; decrypting the stage input data block into a decrypted stage input data block having the first selected width, the decrypted stage input data block comprising a unique combination of data bits for each unique combination of data bits in the stage input data block of the first selected width that is the inverse of the encryption performed by the encryption step; performing a substitution operation on either the encrypted stage input data block or the decrypted stage input data block. The method and apparatus may further comprise selecting as a subsequent stage input data block for the subsequent stage of the series of stages the output of the substitution step or the stage input data block and performing in series the stages of the encryption/decryption operations in a first plurality of stages of the series of stages, each of the stages of the first plurality of stages comprising a round, and repeating this operation for a selected number of times and for a selected number of rounds each of the selected number of times to thereby effect a total number of rounds. The method and apparatus may further comprise performing in any given one of the first plurality of times less than the first plurality of rounds depending upon the total number of rounds necessary; generating each round key by the expansion of a starting key of a second selected width. The second selected width may equal the first selected width; and, the encryption step may further include performing an affine transformation and the decryption step may further include performing an inverse of the affine transformation.

### BRIEF DESCRIPTION OF THE DRAWING

FIG. 1(a) shows a schematic block diagram of an implementation of the steps of an encryption round according to the present invention;

FIG. 1(b) shows an implementation of a decryption round according to the present invention;

FIG. 2 shows a block diagram of an exemplary key addition step according to the present invention;

FIG. 3 shows a schematic block diagram of a possible substitution circuit according to the present invention;

FIG. 4 shows a schematic block diagram of a possible design for circuitry to perform substitution for both encryption and decryption in a single dual-mode pipeline, according to the present invention;

FIG. 5 shows a schematic block diagram of a circuit for a possible implementation of an inverse affine function used in the present invention;

FIG. 6 shows a schematic block diagram of a circuit for a possible implementation of an affine function used in the present invention;

FIG. 7 shows a schematic block diagram of a shift circuit for 16 octets, i.e., 128 bits in width, useful in implementing an embodiment of the present invention

FIG. 8 shows a shift circuit similar to that of FIG. 7 for 24 octets, i.e., 192 bits in width;

FIG. 9 shows an arrangement similar to FIG.'s 7 and 8 for 32 octets, i.e., 256 bits in width;

FIG. 10 shows a schematic block diagram of possible logic for the implement of the shifts illustrated in FIG.'s 7-9;

FIG. 11 shows a schematic block diagram of a possible logic circuit for inverting the operation of the circuit of FIG. 10 for decryption;

FIG. 12 shows a schematic block diagram of an example of a design of an AES-specific 128-bit block encrypt and decrypt shift stage according to the present invention;

FIG. 13 shows a schematic block diagram of an example of a mix columns stage according to the present invention;

FIG. 14 shows a schematic block diagram of an inverse mixing logic circuit that can be utilized in decryption according to the present invention;

FIG. 15 shows a schematic block diagram of an octet-wise multiply by 2 circuit useful with an embodiment of the present invention;

FIG. 16 shows a schematic block diagram of an octet-wise multiply by 3 circuit useful with an embodiment of the present invention;

FIG. 17 shows a schematic block diagram of an octet-wise multiply by 9 circuit useful with an embodiment of the present invention;

FIG. 18 shows a schematic block diagram of an octet-wise multiply by b circuit useful with an embodiment of the present invention;

FIG. 19 shows a schematic block diagram of an octet-wise multiply by d circuit useful with an embodiment of the present invention;

FIG. 20 shows a schematic block diagram of an octet-wise multiply by e circuit useful with an embodiment of the present invention;

FIG. 21 shows a schematic block diagram of an octet-wise divide by 2 circuit useful with an embodiment of the present invention;

FIG. 22 shows a schematic block diagram of an overview of a possible data encryption/decryption pipeline according to a possible embodiment of the present invention;

FIG. 23 shows a schematic block diagram of an example of an implementation of a startup round executing the startup conditioning referenced in FIG. 22;

FIG. 24 shows a schematic block diagram of an exemplary implementation of the flow of data through any of the intermediate rounds shown in FIG. 22;

FIG. 25 shows a schematic block diagram of an example of an implementation of a final conditioning round as shown in FIG. 22;

FIG. 26 shows a schematic block diagram of an example of a case of the operation of a parallel key expansion pipeline along with a data pipeline, for both encryption and decryption for data and key each of 128 bits in width, according to the present invention;

FIG. 27 shows a schematic block diagram of an example of a case of the operation of a parallel key expansion pipeline along with a data pipeline, for encryption and for a data width of 128 bits and a key of 192 bits in length, according to the present invention;

FIG. 28 shows a schematic block diagram of an example of a case of the operation of a parallel key expansion pipeline along with a data pipeline, for decryption and for a data width of 128 bits and a key of 192 bits in length, according to the present invention;

FIG. 29 shows a schematic block diagram of an example of a case of the operation of a parallel key expansion pipeline along with a data pipeline, for encryption and for a data width of 128 bits and a key of 256 bits in length, according to the present invention;

FIG. 30 shows a schematic block diagram of an example of a case of the operation of a parallel key expansion pipeline along with a data pipeline, for decryption and for a data width of 128 bits and a key of 256 bits in length, according to the present invention;

FIG. 31 shows a schematic block diagram of an example of a case of the operation of a parallel key expansion pipeline along with a data pipeline, for encryption and for a data width of 192 bits and a key of 128 bits in length, according to the present invention;

FIG. 32 shows a schematic block diagram of an example of a case of the operation of a parallel key expansion pipeline along with a data pipeline, for decryption and for a data width of 192 bits and a key of 128 bits in length, according to the present invention;

FIG. 33 shows a schematic block diagram of an example of a case of the operation of a parallel key expansion pipeline along with a data pipeline, for encryption and decryption, and for a data width of 192 bits and a key of 192 bits in length, according to the present invention;

FIG. 34 shows a schematic block diagram of an example of a case of the operation of a parallel key expansion pipeline along with a data pipeline, for encryption and for a data width of 192 bits and a key of 256 bits in length, according to the present invention;

FIG. 35 shows a schematic block diagram of an example of a case of the operation of a parallel key expansion pipeline along with a data pipeline, for decryption and for a data width of 192 bits and a key of 256 bits in length, according to the present invention;

FIG. 36 shows a schematic block diagram of an example of a case of the operation of a parallel key expansion pipeline along with a data pipeline, for encryption and decryption and for a data width of 256 bits and a key of 128 bits in length, according to the present invention;

FIG. 37 shows a schematic block diagram of an example of a case of the operation of a parallel key expansion pipeline along with a data pipeline, for encryption and for a data width of 256 bits and a key of 192 bits in length, according to the present invention;

FIG. 38 shows a schematic block diagram of an example of a case of the operation of a parallel key expansion pipeline along with a data pipeline, for decryption and for a data width of 256 bits and a key of 192 bits in length, according to the present invention;

FIG. 39 shows a schematic block diagram of an example of a case of the operation of a parallel key expansion pipeline along with a data pipeline, for encryption and decryption and for a data width of 256 bits and a key of 256 bits in length, according to the present invention;

FIG. 40 shows a schematic block diagram of an example of an implementation of a portion of a logic circuit for key expansion in, e.g., an AES-only pipeline with a fixed 128-bit data block size and a variable key length, according to the present invention;

FIG. 41 shows a schematic block diagram of an example of an implementation of another portion of a logic circuit for key expansion in, e.g., an AES-only pipeline with a fixed 128-bit data block size and a variable key length, according to the present invention;

FIG. 42 shows a schematic block diagram of an example of an implementation of another portion of a logic circuit for key expansion in, e.g., an AES-only pipeline with a fixed 128-bit data block size and a variable key length, according to the present invention;

FIG. 43 shows a schematic block diagram of an example of an implementation of a portion of a logic circuit for key expansion in, e.g., a full Rijndael pipeline with 128/192/256-bit data block sizes and a variable key length, according to the present invention;

FIG. 44 shows a schematic block diagram of an example of an implementation of another portion of a logic circuit for key expansion in, e.g., a full Rijndael pipeline with 128/192/256 bit data block sizes and a variable key length, according to the present invention; and,

FIG. 45 shows a schematic block diagram of an example of an implementation of another portion of a logic circuit for key expansion in, e.g., a full Rijndael pipeline with 128/192/256 bit data block sizes and a variable key length, according to the present invention.

### DETAILED DESCRIPTION OF A PREFERRED EMBODIMENT

The basic building block of a design of a pipelined encryption and decryption circuit according to the present invention is the gate logic to implement a single round. In very high throughput applications, e.g., as addressed herein, many instances of this basic round logic could be required. A first way to expand throughput might be to connect a serial cascade of the basic round logic. If the number of serial rounds implemented is less than the 10 to 14 rounds needed to perform the complete encryption or decryption of a block, additional control and data logic might be required to provide, e.g., multiple passes through the pipeline for complete processing. With the exception of a pipeline length of 2 rounds, additional logic would be needed in the pipeline to bypass some rounds in the pipeline in order to perform the correct number of rounds. For example a 5-round pipeline utilizing three cycles through the pipeline would yield 15 rounds, not the 10, 12 or 14 specified. This might be done with, e.g., 2 skipable rounds in the pipeline. In this manner, 10=3+3+4, with the circuitry enabling two skipped rounds in the first two passes and one in the third pass, 12=4+4+4, with one skipped round in each pass and 14=5+5+4, with only a skipped round at the end of the third pass. With a pipeline length of two, no rounds skipping logic is needed inside the pipeline, but one or two pipeline cycles could have to be suppressed for the 10 and 12 round modes. These tradeoffs can be made less complicated for versions that implement a single key and block size, and thus also have a fixed number of rounds. Otherwise the pipeline should be, e.g., structured and timed for the longest case, i.e., 14 rounds, with control circuitry to produce the correct number of total rounds with a pipeline of a given number of rounds for the desired output for all cases.

Rijndael and AES can in principle be implemented in completely unclocked logic. The relationship between the inputs and the output can be entirely composed of exclusive-or, reordering, multiplexers and substitution tables. However this could result in data flow consecutively through a long cascade on the order of 100 gates where every output is a function of every input. Within a pipeline, the throughput per clock cycle can be increased by introducing synchronously clocked latches at key points along the pipeline. By doing this, each clocked stage can be constructed to perform a part of the encryption or decryption for a different key and data block.

While the results for any one input are delayed by the length of the pipeline, the aggregate throughput can be the product of the clock speed and the number of clocked stages. Because the maximum clock rate for the pipeline has to be matched to the stage with the slowest propagation time, in the ideal the stages would all have essentially the same propagation time. By putting latches between each round, this delay can be closely matched. It could also be possible to latch every other round (or more), especially if other parts of the system-level design impose a relatively slow clock. It might even be possible to split a round into multiple pipeline stages, but at some point the additional time added by the setup and hold time of the latches being introduced could absorb the improvement in time from a shorter logic chain within a stage of the round.

In some applications, pipeline design may be influenced by other factors. In IPSec, the use of cipher feedback mode has often been specified. In cipher feedback mode the encrypted version of a block is exclusive-or'ed with the following block before encrypting it. In this mode the latency between the start and completion of the encryption becomes a critical factor in the maximum permissible rate for a single data stream. While the overall length of the encryption logic chain sets a strict lower bound on the possible latency, fewer inter-stage latches can result in lower latency at the cost of lower aggregate pipeline throughput.

If the throughput of a maximally pipelined 14-round long implementation is insufficient, multiple independent pipelines could be used increase the aggregate bandwidth. In applications where the balance between encryption and decryption traffic can be approximated with a mix of encryption-only and decryption-only pipelines, each pipeline can be made marginally simpler and faster by optimizing for a single encryption/decryption function, mostly by reducing the amount of multiplexing required. The most common case of matching traffic is router and link-level encryption where input and output data rates are identical with an even number of pipelines in the implementation.

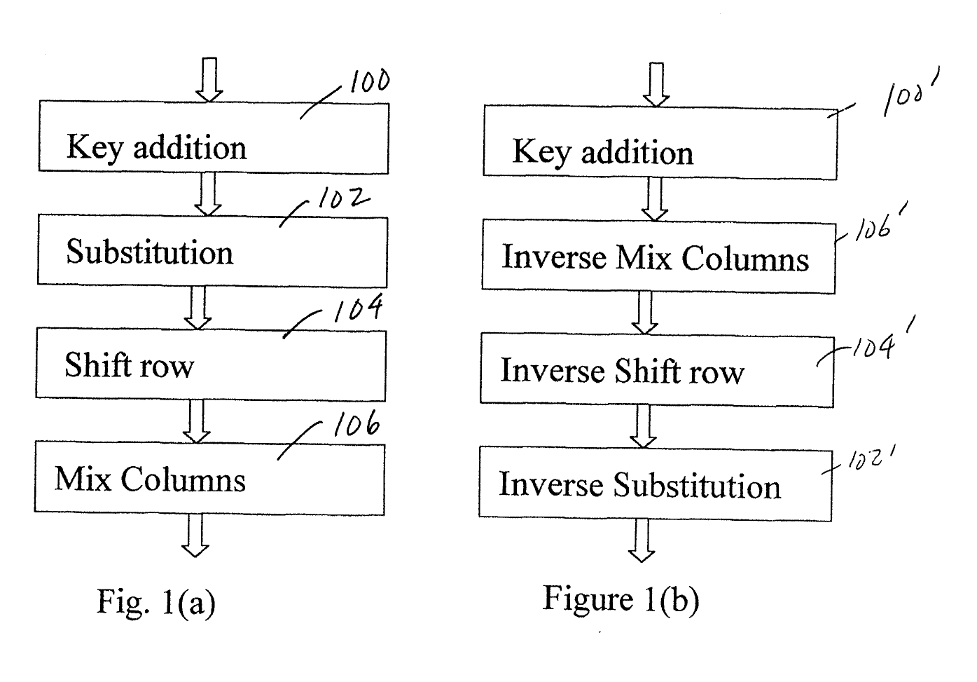

Turning now to FIG. 1(a) there is shown the steps that may be implemented within an encryption round, which are, e.g., in order, key addition with at least some part of the expanded key in block 100, substitution in block 102, shift rows in block 104 and mix columns in block 106, which in the final round can be replaced with a simple final key addition. FIG. 1(b) shows a reverse implementation in a decryption mode of key addition, 100′, inverse mix columns 106′, inverse shift row 104′ and inverse substitution 102′.

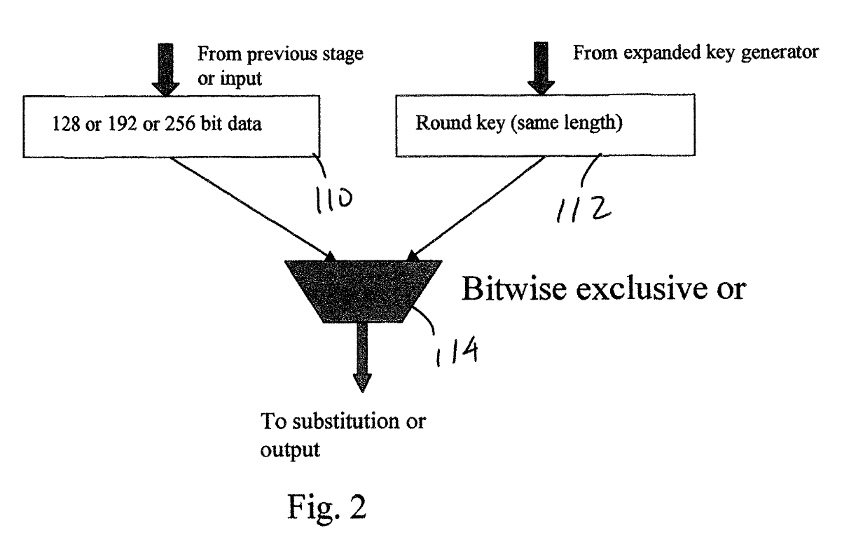

Turning now to FIG. 2, there is shown an example of a key addition step. In block 110 there is contained the input data block as input as plain text for encryption or as passed to round Rᵢ from round Rᵢ₋₁, which in Rijndael can be of 128, 192 or 256 bits in length, but in AES can be only 128 bits in length. In block 112 can be contained a round key for the round Rᵢ, of the same length as the data block in block 110. Each respective bit of the bits in the input data block 110 can be, e.g., exclusive-or'ed (XOR'ed) with each respective one of the bits of the round key contained in block 112 in a bitwise exclusive-or circuit (Xor) 114. The round key contained in block 112 can be created by key expansion, as more fully explained below. This expanded key can be derived from the input key essentially by copying and scrambling the input key enough times to provide key bits for all the key additions in the exclusive-or circuit 114 for each required round. For an input data block in box 110 that is less than the expanded key length in box 112, e.g., for AES with a 128 bit data block and a key length of 192 or 256, the data pipeline, including the exclusive-or circuit 114 can be of the maximum width of 256 bits, with, e.g., the right-most bits in excess of the size of the data block ignored in encryption. Throughout this disclosure, exclusive-or or Xor denotes a binary function of two or more inputs that has an output true (i.e., 1 in positive logic) when an odd number of inputs are true, and output false (i.e., 0 in positive logic) when an even number of inputs are true. With a large number of inputs it is sometimes referred to as a parity generator. This is a standard gate function in virtually every digital logic family and design library.

It was pointed out in B. Weeks, et al., Hardware Performance Simulations of Round 2 Advanced Encryption Standard Algorithms, Third NIST Advanced Encryption Standard Candidate Conference, Apr. 13-14, 2000, New York, N.Y., pp.826-304, the disclosure of which is hereby incorporated by reference, that the key expansion process can be performed in a pipelined fashion in parallel with the use of the key in, e.g., an encryption/decryption pipeline. Key addition is the only step that depends directly on the encryption key. With a fully parallel implementation for a 256 bit data block (Rijndael, not AES), short data blocks can have their bits positioned at any convenient positions within the longer block, as long as the matching bits from the expanded key are properly paired with the data bits. As a practical matter, left alignment is generally less complex considering all aspects of data pipelining. Further, since much of the processing can be applied, e.g., to 8-bit and 32-bit components of the key and data, alignment to boundaries that are multiples of 32 bits can be essential.

According to the present invention, short data blocks can be aligned without gaps in the leftmost 128 or 192 bits of a 256-bit data path. In any event, the unused bit positions can simply be ignored when processing narrower blocks. This often can simplify the logic for the right half of the data paths.

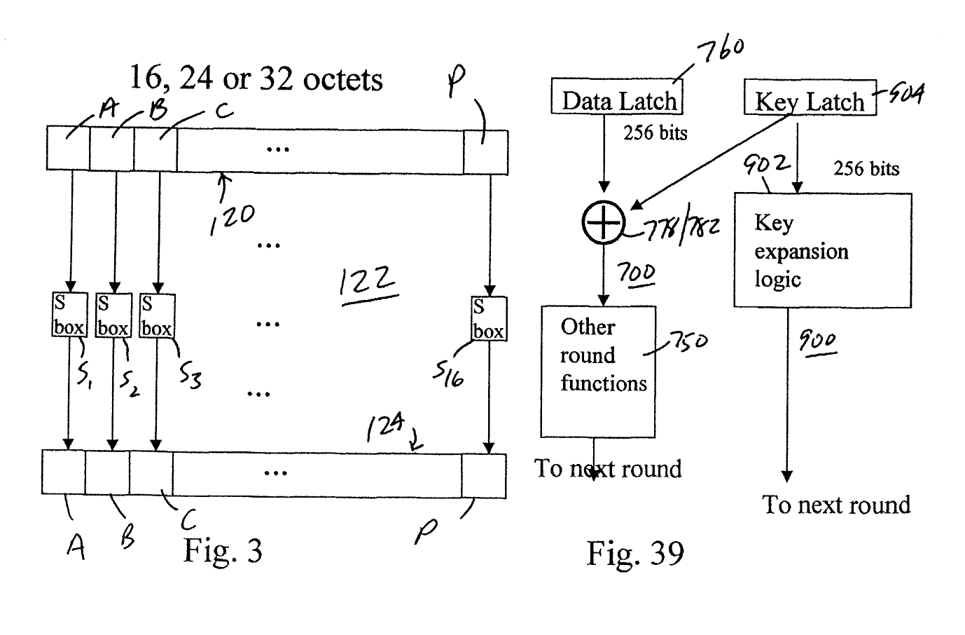

The output of the exclusive-or circuit 114 of FIG. 2 can be a data block of the same width as was in block 110, which can form an input 120 to a substitution circuit 122, as shown in more detail in FIG. 3. The input data block can be treated as a series of 8-bit octets A, B, C . . . to P in the case of 128 bits, i.e., 16 octets, A, B, C . . . XH, in the case of 192 bits, i.e., 24 octets and A, B, C . . . XP in the case of 256 bits, i.e., 32 octets. Each octet can be used as an index into a substitution table (or inverse table during decryption), and the output into data block 124 can be the octet value in the table within the respective S-Box, e.g., S1 . . . S16, i.e., the A, B, C . . . P in the substitution stage data block 124. Such a look-up table is referred to herein as an S-Box S1, S2, S3 . . . S16 or S24 or S32. Because the octets are independent in this step, maximum speed can be achieved by providing, e.g., 32 copies of the respective S-Boxes, S1 . . . S32, for 256-bit Rijndael data blocks, or, e.g., 16 copies of the table S1 . . . S16, for 128-bit AES, which can be implemented, e.g., as a read-only memory, and processing the entire block 120 in parallel, as illustrated in FIG. 3.

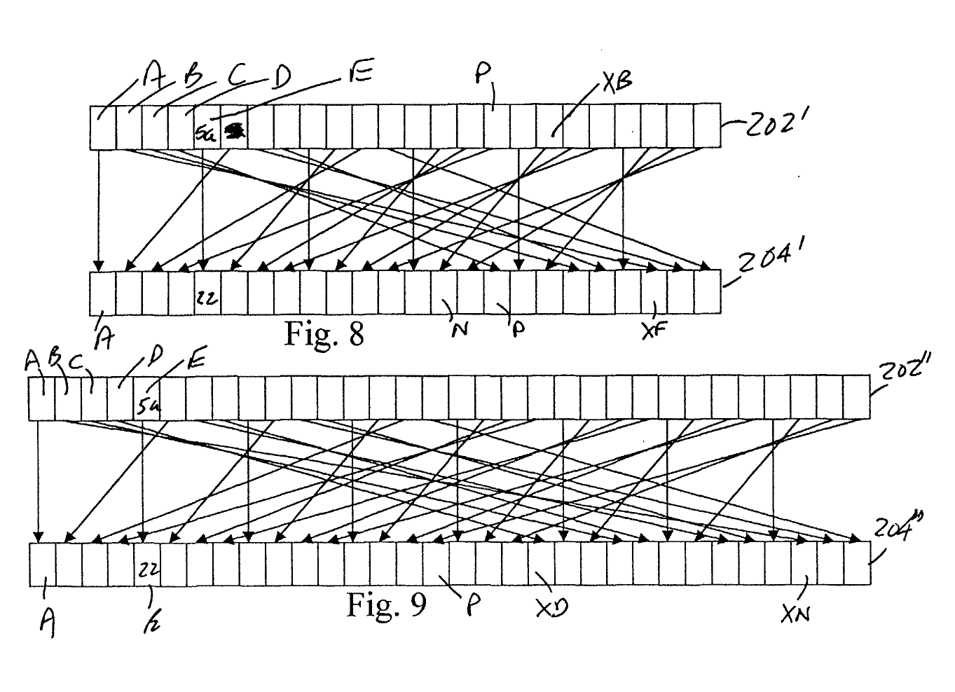

This substitution step can have the highest gate complexity in an implementation according to the present invention, since each table could contain 256 octets of data, 2048 bits in all. In applications where speed is less important, overall complexity could be reduced by implementing fewer copies of the tables, adding multiplexers and latches and using multiple clock cycles to perform substitution over different parts of the data block 120 in turn in each round. V. Rijmen, “Efficient Implementation of the Rijndael S-box”, http://www.esat.kuleven.ac.be/˜rijmen/rijndael/sbox.pdf, (“Rijmen”) the disclosure of which is hereby incorporated by reference, suggests a possible implementation of an S-box with substantially less gate complexity, e.g., perhaps 3 to 4 times less, but with a significant penalty in throughput speed. In J. Daemen, V. Rijmen, “The Block Cipher Rijndael,” Smart Card Research and Applications, LNCS 1820, J. Quisquater and B. Schneier, Eds., the disclosure of which is hereby incorporated by reference, the authors note that the substitution table contained in each S-Box, e.g., S1 . . . S16, in FIG. 3, is the composition of two functions. One function is a complex, nonlinear inversion that is the same for encryption or decryption. The other function is different for encryption and decryption but can be implemented with a few simple gates. This makes it possible to perform encryption and decryption with half as many tables, though much of the remaining logic becomes more complex as additional multiplexing is needed to steer data through variations in the processing steps between encryption and decryption. The result would require somewhat over half the total implementation logic, without the ability to do simultaneous encryption and decryption. Of course individual blocks could alternate between encryption and decryption for about half the throughput for each mode. In applications where there is a substantial difference between the volume of encryption and decryption traffic, overall hardware utilization would increase. For encryption only or decryption only, the necessary substitution tables are given in the Rijndael and AES standards documents, referenced above. The encryption substitution table is enumerated, e.g., in FIG. 8 in the FIPS AES Standard and the decryption substitution table is enumerated in FIG. 9 in FIPS AES Standard.

The encryption version of the table, according to the present invention, can also be used in the key generation pipeline for both encryption and decryption, thereby lowering the total number of S-Boxes required. For an encryption-only pipeline and any key expansion pipeline, the 256-octet encryption table can be the fastest implementation. In a decryption-only pipeline similarly the decryption table can be the fastest.

However, for a single pipeline to do both encryption and decryption, both the substitution and its inverse are required. One approach could be to have a table that is the concatenation of the two tables and, e.g., use an encryption/decryption mode control signal as, e.g., a ninth address line to select the proper one of, e.g., 512 octets in the concatenated table. This implementation can be nearly as fast as a single mode table but doubles the table space required. Because the table space already can dominate the gate complexity of a heavily parallel design, this nearly doubles the overall gate count, and the additional multiplexing required along the pipeline to handle other differences between encryption and decryption could likely result in a slower design than simply having independent encrypt-only and decrypt-only pipelines with nearly the same gate count. Rijmen suggests, without providing any details, one might separate the affine transformation from the multiplicative inverse used to generate the substitution tables contained in each respective S-Box, which might allow using the substitution table for both encryption and decryption directions in the pipeline.

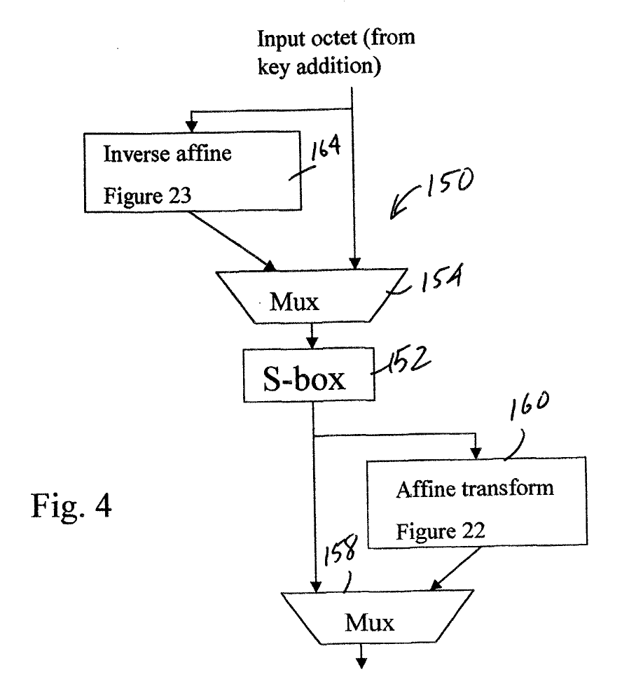

Turning now to FIG. 4, there is shown a possible design for circuitry to perform substitution for both encryption and decryption in a single dual-mode pipeline 150 using a single 256-octet table 152. Two multiplexers 154, 158, respectively, can be used to route the data through a shared substitution table 152 and affine transformation 160 or inverse affine transformation 164 in the proper order. This can result in a somewhat slower substitution stage because this adds two multiplexers and an additional affine function into the pipeline in each round, but this could be used to reduce overall gate count on the order of 40% compared to either the utilization of two one-way pipelines or the inclusion of both encryption and decryption S-Box look-up tables.

For decryption in the possible circuit shown in FIG. 4, the octets of a data block can be is transformed by a inverse affine function, as shown, e.g., in FIG. 5, followed by a version of the S-box 152 that contains only the GF (256) multiplicative inverse of each input octet. For encryption, the data block could first be transformed by the same modified multiplicative inverse S-box 152, then followed by an affine function as diagrammed, e.g., in FIG. 6. The first multiplexer 154 can control the input to the S-Box 152, either direct for encryption followed by the affine function of box 160, or after the inverse affine function applied in box 164, for decryption. The second multiplexer 158 determines the proper output, the result of the S-Box 152 for decryption or the output of the affine function performed in box 160 for encryption.

The circuit for an affine function, shown in FIG. 6, can be a hardware realization of the affine function described by matrix equation 5.2 in the FIPS AES Standard, i.e., the matrix version of the transformation bᵢ′=bᵢ⊕b_{(i+4)mod8}⊕b_{(i+5) mod 8}⊕b_{(i+6)mod 8} ⊕b_{(i+7)mod 8}⊕ci for 0≦i≦8, where bᵢ is the ith bit of the byte and cᵢ is the ith bit of a byte c with the value {63} in hexadecimal, i.e., {01100011}, which is implemented by the inversion of the outputs of the Xor gate circuits having the outputs 00, 01, 06 and 06. The inverse affine function and its hardware design can be derived from this affine function. The multiplicative inverse table required is, e.g., as shown below, in the same format as the substitution tables in the FIPS AES Standard. While this table is implied by the mathematical foundations in the FIPS Standard, e.g., in Section 4, it does not appear in the standard.

TABLE 1
AES multiplicative inverse S-Box, showing

| x/y | 0 | 1 | 2 | 3 | 4 | 5 | 6 | 7 | 8 | 9 | a | b | c | d | e | f |
|---|---|---|---|---|---|---|---|---|---|---|---|---|---|---|---|---|
| 0 | 00 | 01 | 8d | f6 | cb | 52 | 7b | d1 | e8 | 4f | 29 | c0 | b0 | e1 | e5 | c7 |
| 1 | 74 | b4 | aa | 4b | 99 | 2b | 60 | 5f | 58 | 3f | fd | cc | ff | 40 | ee | b2 |
| 2 | 3a | 6e | 5a | f1 | 55 | 4d | a8 | c9 | c1 | 0a | 98 | 15 | 30 | 44 | a2 | c2 |
| 3 | 2c | 45 | 92 | 6c | f3 | 39 | 66 | 42 | f2 | 35 | 20 | 6f | 77 | bb | 59 | 19 |
| 4 | 1d | fe | 37 | 67 | 2d | 31 | f5 | 69 | a7 | 64 | ab | 13 | 54 | 25 | e9 | 09 |
| 5 | ed | 5c | 05 | ca | 4c | 24 | 87 | bf | 18 | 3e | 22 | f0 | 51 | ec | 61 | 17 |
| 6 | 16 | 5e | af | d3 | 49 | a6 | 36 | 43 | f4 | 47 | 91 | df | 33 | 93 | 21 | 3b |
| 7 | 79 | b7 | 97 | 85 | 10 | b5 | ba | 3c | b6 | 70 | d0 | 06 | a1 | fa | 81 | 82 |
| 8 | 83 | 7e | 7f | 80 | 96 | 73 | be | 56 | 9b | 9e | 95 | d9 | f7 | 02 | b9 | a4 |
| 9 | de | 6a | 32 | 6d | d8 | 8a | 84 | 72 | 2a | 14 | 9f | 88 | f9 | dc | 89 | 9a |
| a | fb | 7c | 2e | c3 | 8f | b8 | 65 | 48 | 26 | c8 | 12 | 4a | ce | e7 | d2 | 62 |
| b | 0c | e0 | 1f | ef | 11 | 75 | 78 | 71 | a5 | 8e | 76 | 3d | bd | bc | 86 | 57 |
| c | 0b | 28 | 2f | a3 | da | d4 | e4 | 0f | a9 | 27 | 53 | 04 | 1b | fc | ac | e6 |
| d | 7a | 07 | ae | 63 | c5 | db | e2 | ea | 94 | 8b | c4 | d5 | 9d | f8 | 90 | 6b |
| e | b1 | 0d | d6 | eb | c6 | 0e | cf | ad | 08 | 4e | d7 | e3 | 5d | 50 | 1e | b3 |
| f | 5b | 23 | 38 | 34 | 68 | 46 | 03 | 8c | dd | 9c | 7d | a0 | cd | 1a | 41 | 1c |

Turning now to FIG.'s 7-11 there is shown an example of a shift stage.

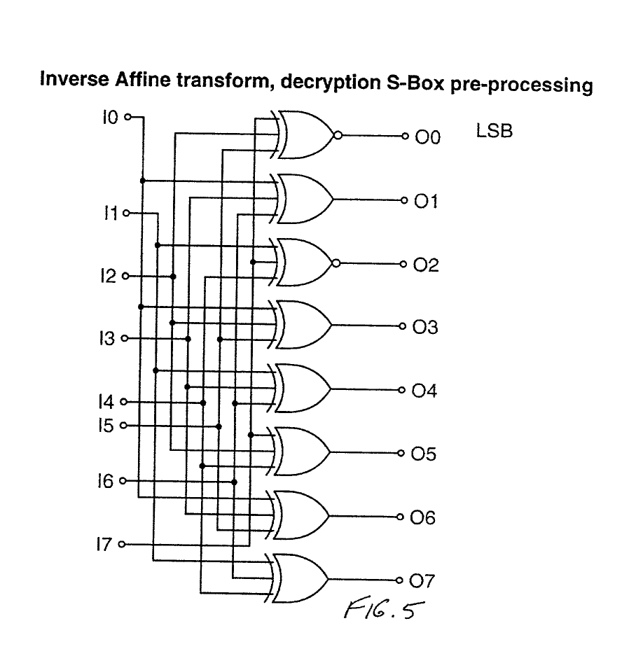

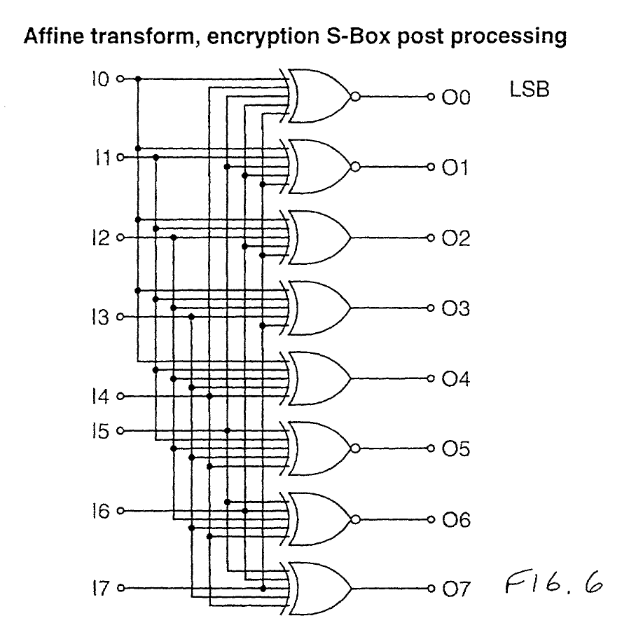

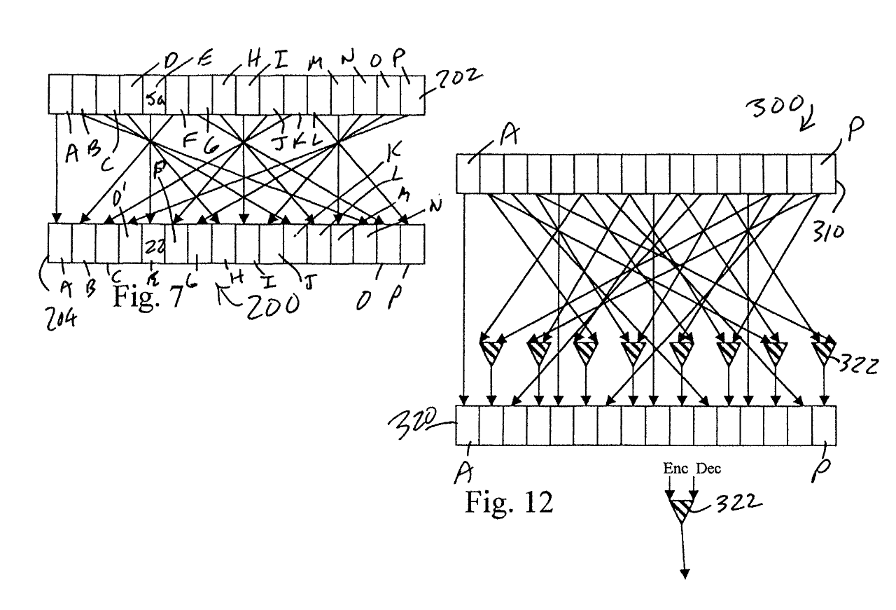

The individual octets of a data block 202, e.g., A . . . P, can be rearranged according to the shift performed in the shift stage 200, as shown in FIG. 7 for sixteen octets, i.e., a block of 128 bits. In the case of a fixed data block width implementation, a hardware implementation requires no logic functions at all, data can simply be wired to the proper output octets, A . . . P, in the shift stage output 204, forming the input to a following stage. FIG.'s, 7, 8 and 9 show arrangements, e.g., for 128, 192 and 256 bit data blocks respectively, and represent a pictorial version of the data in Table 2 for the corresponding encryption size. For example, for the octet in byte E, as shown in FIG. 7, the output of the shifting stage would contain the same octet in block E in the output data block 204. On decryption, the octet in byte E in the input stage 202 would also map to the Octet E in the output 204 of the stage. Similarly, for the octet in byte F of data block 202,202′ or 202″ shown in FIG.'s 7, 8 and 9, the transformation would map the byte to B of output 204, 204′ and 204″ shown in FIG.'s 7, 8 and 9. In decryption, the octets A and B of the data input block 202, 202′ or 202″ would be switched, respectively, to the octets A and F of the data output block 204, 204′ or 204″. While Rijndael provides for all three widths, the current AES proposed standard calls for 128 bit data blocks, only, as in FIG. 7.

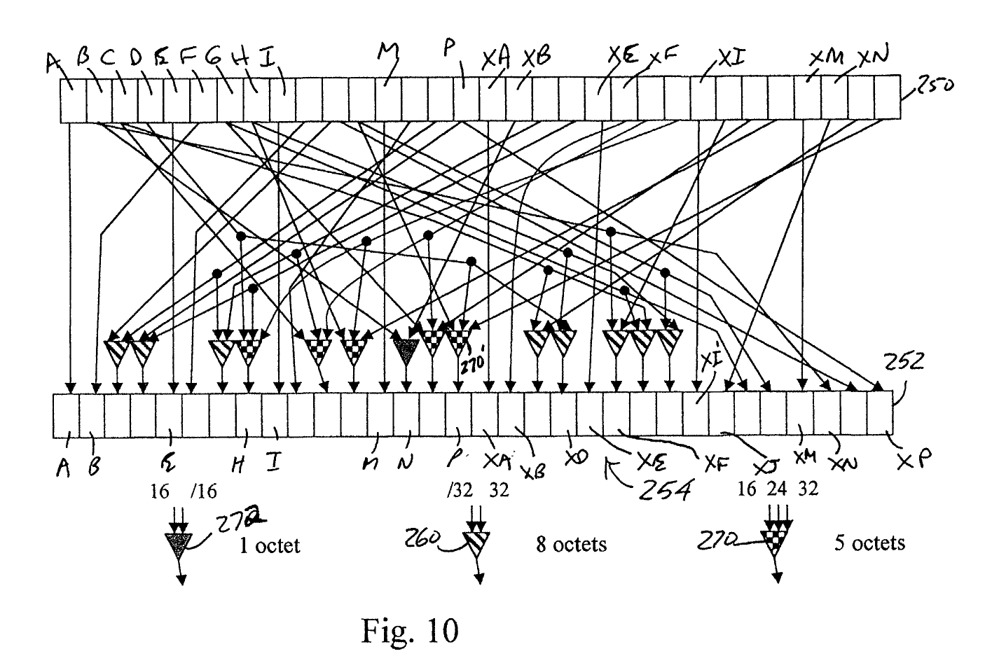

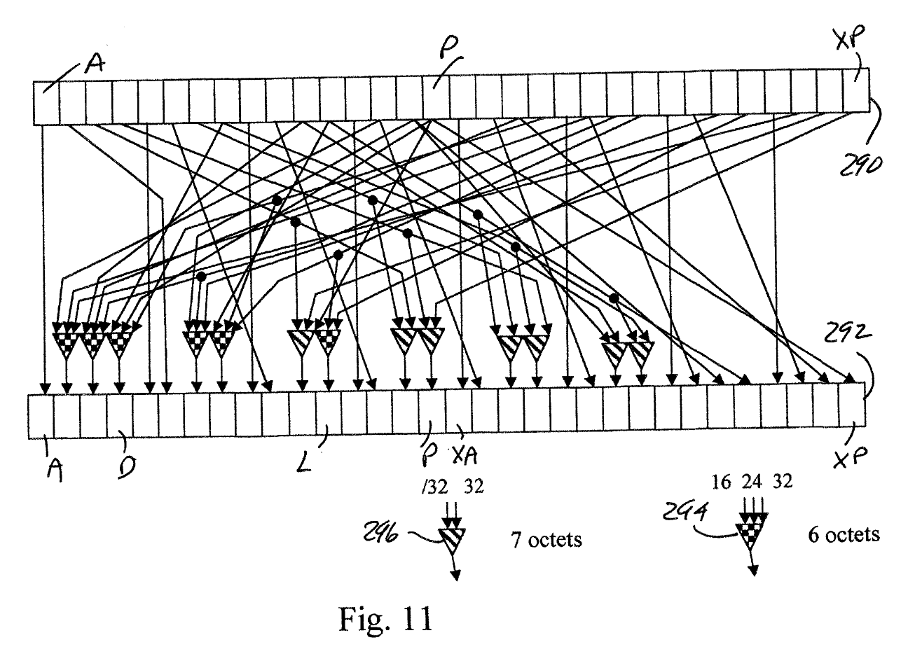

According to the present invention, a design of a shift stage for a full Rijndael implementation, can utilize input blocks shorter than 256 bits, which are, e.g., packed together as the leftmost 128 or 192 bits in a 256-bit wide data path. With this alignment, as illustrated in FIG. 10 (encryption) or FIG. 11 (decryption), it is shown that multiplexer gate arrays may be used to deliver the proper input octets from the input buffer 250, A . . . XP to each output octet A . . . XP in the stage output data block, e.g., output buffer 252, as implemented in FIG.'s 7, 8 and 9, respectively, for 16, 24 and 32 octets in the input buffers, 202. 202′ and 202″ in FIG.'s 7, 8 and 9. FIG. 10 shows the logic to implement all three columns for encryption and decryption contained in Table 2, which equate to the octet shifts illustrated in FIG.'s 7, 8 and 9, respectively, for 129, 192 and 256 block widths. Some octet positions do not require a multiplexer, either because all three block widths arrange the output octets in the same order (e.g. octets A, E, F, I, etc. in FIG.'s 10 and 11) or because a shorter block (e.g. the rightmost 8 octets in both figures) does not use those octets. In the other positions a two-input multiplexer 260 or three-input multiplexer 270 can be used to select the proper octet for the particular octet location in the output buffer 252, depending upon whether the data block width being used for the encryption in the input data block in input buffer 250 is of 16, 24 or 32 octets in length.

The multiplexers 260, 270 in FIG. 's 10 and 11 actually represent 8 parallel data lines on each input and output to the multiplexer 260, 270, with all 8 inputs from a single source octet A . . . XP from the input buffer 250 passed through to the respective output buffer 252 octet A . . . XP output depending upon the source selection made by the multiplexer 260, 270. For encryption, as illustrated, e.g., in FIG. 10, a total of five three-input multiplexers 270 are used in output positions where the output octet is different for all three key lengths, and each of the three inputs corresponds to a different block width (data block width and key width, which can be the same width). For example, the octet L in input buffer 250 in FIG. 10 is passed through a three-input multiplexer 270 to the output of the multiplexer which is connected to output buffer 252 octet position P, corresponding to output position 16 in Table 2. This corresponds to the shifting in FIG. 7 for a 16 octet data block or key length, with octet location L in both FIG. 7 and FIG. 10 corresponding to input 12 in column 1 of Table 2, 128 bit encryption. Similarly, the same multiplexer 270 connects input octet D to output octet P as is also shown in FIG. 8 for the case of a 192 bit (24 byte) encryption. This corresponds to the input octet 4 in column 2 of Table 2. Finally, the same multiplexer 270 connects the octet XP in input buffer 250 to the output octet P, corresponding to the input octet in input buffer 202″ in FIG. 9, and further corresponding to the entry 32 in column 3 of Table 3 for the output octet position 16, i.e., P.

At nine other positions, two-input multiplexers 260 and 272 can be used to select the proper input octet position for output buffer 252. As indicated in the legend, some of these multiplexers 260 are steered based on whether the input is 16 octets (128 bits) or not, and the remainder on whether the input is 32 octets (256 bits) or not. For decryption, as can be seen in FIG. 11, six three-input multiplexers 294 and 7 two input multiplexers 296 can be used to shift the input decryption octets in buffer 290 into the required output octet positions in output buffer 292, depending upon the modes of the respective multiplexers. For example in this decryption circuit, the encrypted P octet position is shifted to either the K, D or XP positions from whence it came in the inverse encryption function, depending upon the decryption data block length of 16, 24 or 32 octets.

While not shown in the diagrams, the multiplexers 260, 270 and 294, 296 also have control inputs for the input choice, derived from control information about the data block width. In an implementation that combines encryption and decryption into the same data path, the multiplexing becomes more complex with most positions having more inputs (as many as five) depending on width and mode, but the basic concept is the same.

Table 2 summarizes the data sources for each octet output in the shift stage 252, 292, respectively in FIG.'s 10 and 11, for a variable-width unidirectional shift stage for Rijndael. For the proposed AES standard, only the 128-bit columns and the first 16 rows matter, and only the even numbered positions require a two-input multiplexer for a combined unidirectional encryption/decryption pipeline. FIG. 12 shows an example of such a design of an AES-specific 128-bit block encrypt and decrypt shift stage 300 that implements the combined functions of the 128-bit columns in Table 2. The octet positions in the input buffer 310 can be passed to the appropriate output buffer 320 position by, as necessary, the two-input multiplexers 322 according to whether or not the operation in this stage 300 is encryption or decryption.

TABLE 2
Shift stage octet reordering sources

| | Encryption | | | Decryption | | |
|---|---|---|---|---|---|---|
| Output | 128 | 192 | 256 | 128 | 192 | 256 |
| position | bit | bit | bit | bit | bit | bit |
| 1 | 1 | 1 | 1 | 1 | 1 | 1 |
| 2 | 6 | 6 | 6 | 14 | 22 | 30 |
| 3 | 11 | 11 | 15 | 11 | 19 | 23 |
| 4 | 16 | 16 | 20 | 8 | 16 | 20 |
| 5 | 5 | 5 | 5 | 5 | 5 | 5 |
| 6 | 10 | 10 | 10 | 2 | 2 | 2 |
| 7 | 15 | 15 | 19 | 15 | 23 | 27 |
| 8 | 4 | 20 | 24 | 12 | 20 | 24 |
| 9 | 9 | 9 | 9 | 9 | 9 | 9 |
| 10 | 14 | 14 | 14 | 6 | 6 | 6 |
| 11 | 3 | 19 | 23 | 3 | 3 | 31 |
| 12 | 8 | 24 | 28 | 16 | 24 | 28 |
| 13 | 13 | 13 | 13 | 13 | 13 | 13 |
| 14 | 2 | 18 | 18 | 10 | 10 | 10 |
| 15 | 7 | 23 | 27 | 7 | 7 | 3 |
| 16 | 12 | 4 | 32 | 4 | 4 | 32 |
| 17 | | 17 | 17 | | 17 | 17 |
| 18 | | 22 | 22 | | 14 | 14 |
| 19 | | 3 | 31 | | 11 | 7 |
| 20 | | 8 | 4 | | 8 | 4 |
| 21 | | 21 | 21 | | 21 | 21 |
| 22 | | 2 | 26 | | 18 | 18 |
| 23 | | 7 | 3 | | 15 | 11 |
| 24 | | 12 | 8 | | 12 | 8 |
| 25 | | | 25 | | | 25 |
| 26 | | | 30 | | | 22 |
| 27 | | | 7 | | | 15 |
| 28 | | | 12 | | | 12 |
| 29 | | | 29 | | | 29 |
| 30 | | | 2 | | | 26 |
| 31 | | | 11 | | | 19 |
| 32 | | | 16 | | | 16 |

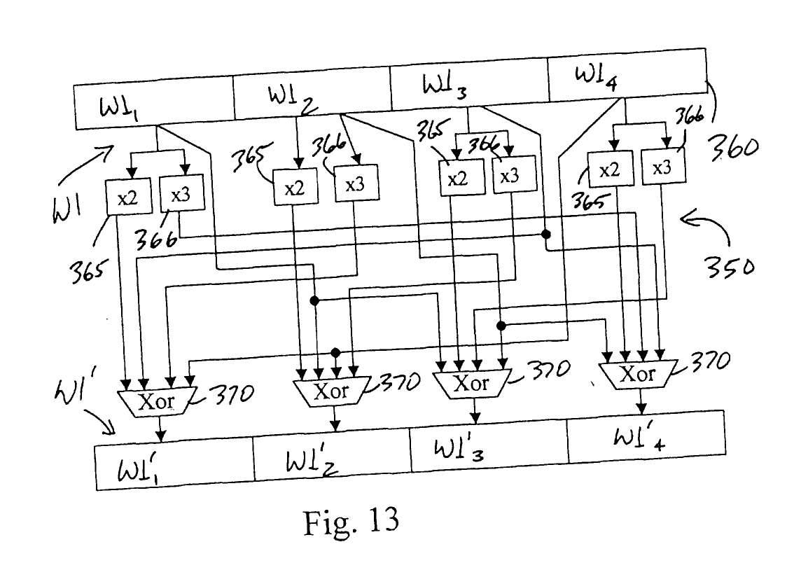

In a mix columns stage 350, for example as depicted in FIG. 13, the input in an input buffer 360 can be divided into consecutive 32-bit words W1, W2, W3, W4, and each word W1-W4 in the input buffer 360 can be processed independently and identically. In Rijndael there may be 4, 6 or 8 such words W1-W4, W1-W6 or W1-W8, in AES there are always four words W1-W4. Each input octet W1₁, W1₂, W1₃, and W1₄ in a word WI can be used to compute the four octets W1₁′, W1₂′, W1₃′, and W1₄′ in the output 32-bitwords, e.g., W11′. FIG. 13 depicts the logic that can be used to mix data from four different octets W1₁, W1₂,W1₃, and W1₄ to generate four replacement octets W1₁′, W1₂′, W1₃′, and W1₄′. Each output octet W1₁′, W1₂′, W1₃′, and W1₄′ is the bitwise exclusive-or based on all four input octets, denoted by the boxes 370 labeled X or in FIG. 13 Before passing the data comprising each octet W1₁, W1₂, W1₃, and W1₄ to two of the output Xor circuits 370, as shown in FIG. 13, the octet is transformed (or multiplied) by, respectively, operations x2 and x3 in GF (2ⁿ), i.e., GF (256) in boxes 365, 366, as will be explained in more detail below. This corresponds to a reduction to an octet through the multiplication by an irreducible polynomial that has an inverse. FIG. 13 shows a routing of the data that can be used from each input W1₁, W1₂, W1₃, and W1₄ to the Xor blocks 370, the outputs of each of which is connected respectively to an output octet W1₁′, W1₂′, W1₃′, and W1₄′.

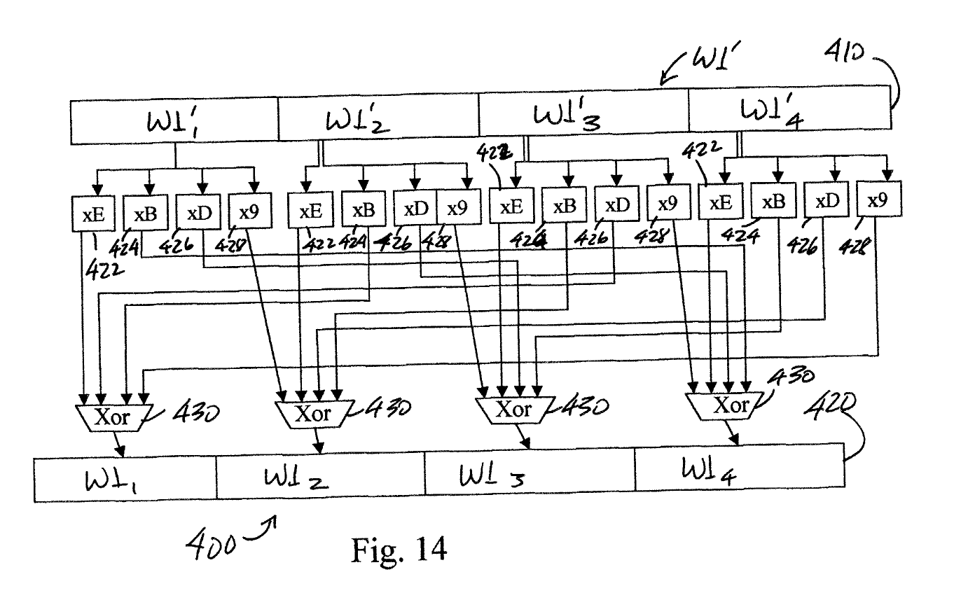

FIG. 14 shows a mixing logic that can be utilized in decryption. The basic relationship between word W1, W2, W3, W4 and octet W1₁, W1₂, W1₃, and W1₄ and W1₁′, W1₂′, W1₃′, and W1₄′ positions of inputs and outputs is identical to encryption, but the multiplier octets W1₁′, W1₂′, W1₃′, and W1₄′ are in the input buffer 410 of the stage 400, the octets W1₁, W1₂, W1₃, and W1₄ are in the output buffer 420, and the transformations are different, being the inverse of the irreducible polynomial utilized in the mix column stage of FIG. 13. Each input octet W1₁′, W1₂′, W1₃′, and W1₄′ can be multiplied by the values, xE, xB, xD and x9, in boxes 422, 424, 426 and 428, respectively, before delivery to the final Xor gates 430 as shown in FIG. 14. The transformation in FIG. 14 is the inverse of the transformation in FIG. 13.

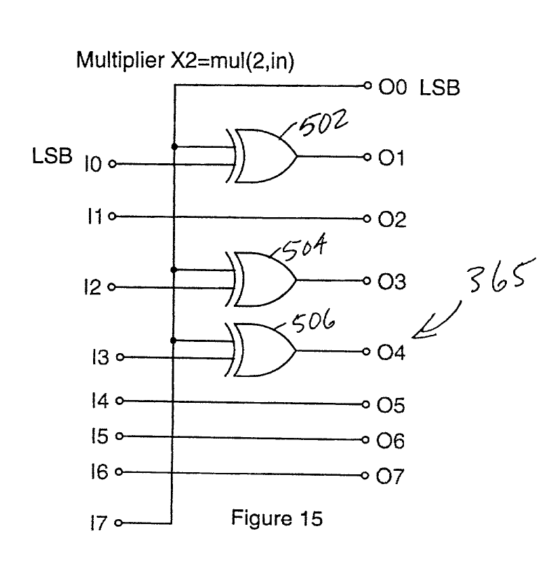

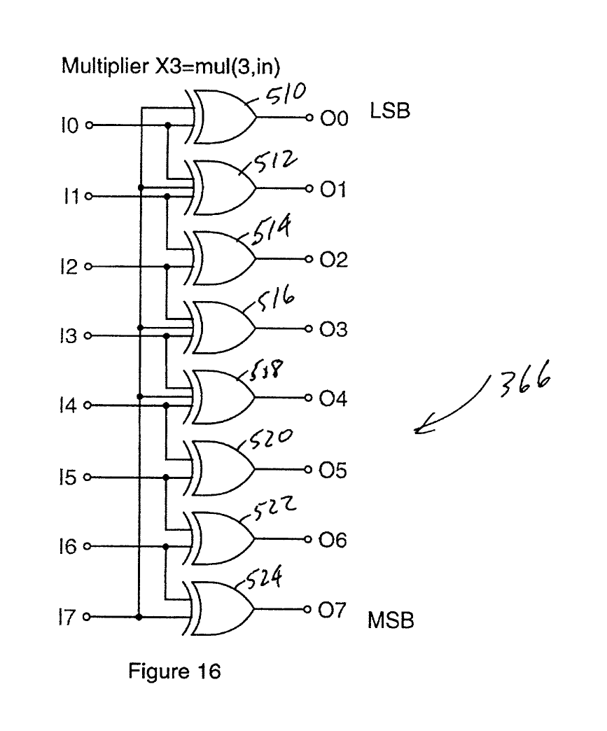

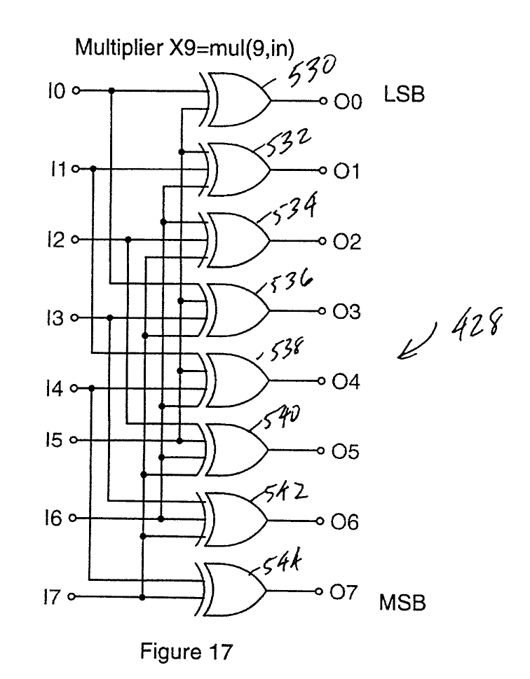

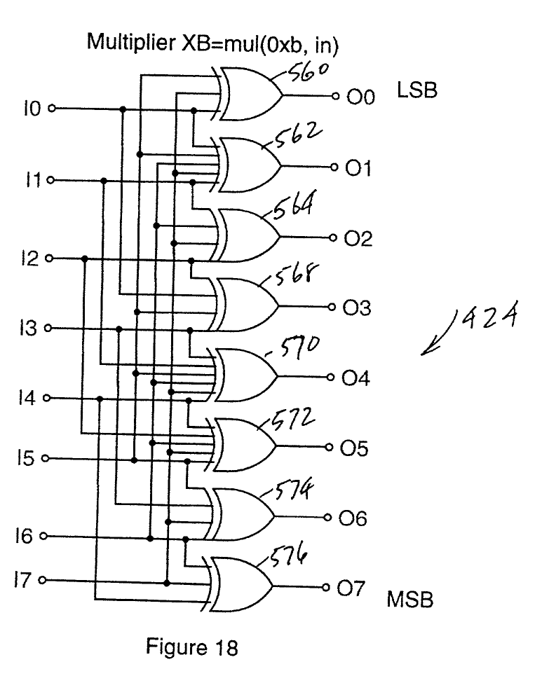

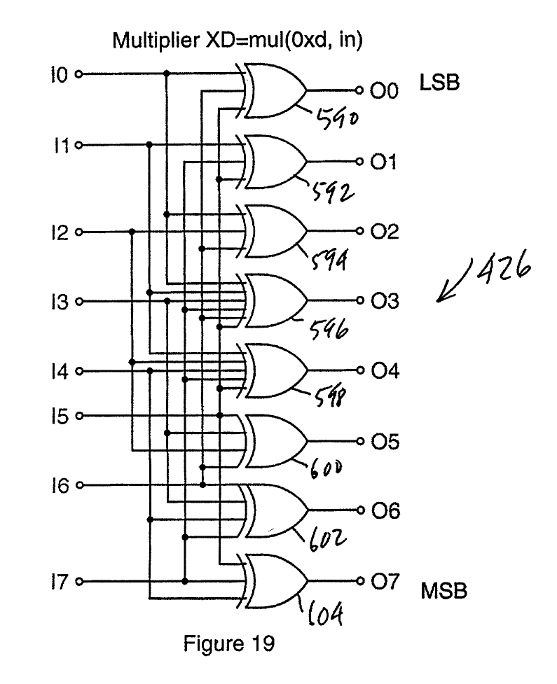

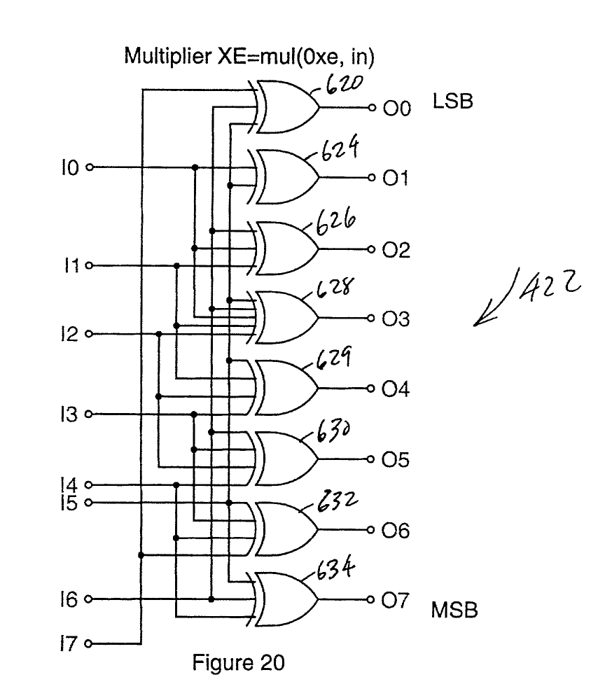

FIG's 15 through 20 show gate-level implementations that may be used for the multipliers x2, 365, x3, 366, xE, 422, xB, 424, xD, 426 and x9,428, that can be used in, respectively the mixing stages 350 in FIG. 13 and 400 in FIG. 14. This implements polynomial multiplication by a constant in GF (2ⁿ), i.e., GF (256). Each of these multipliers 365, shown in FIG. 15, 366, shown in FIG. 16, 428, shown in FIG. 17, 424, shown in FIG. 18, 426, shown in FIG. 19 and 422, shown in FIG. 20, can consist entirely of exclusive-or gates, e.g., Xor gates 502, 504 and 506, shown in FIG. 15, in most cases eight each, e.g., the Xor gates 510, 512, 514, 516, 518, 520, 522 and 524 in FIG. 16. In FIG. 15, multiplier x2 365 can be the implementation of the box labeled x2 in the mixing stage 350 shown in FIG. 13. Multiplier x2 365 can also be used in the generation of an rcon parameter in the key expansion process.

FIG. 16, illustrates multiplier x3 366 in FIG. 13. FIG. 17, illustrates multiplier x9 428 in the decryption mixer, shown in FIG. 14. Similarly, FIG.'s 18 through 20 depict what can be utilized for the multipliers xB, 424, xD 426 and xE 422, respectively, shown in FIG. 14 depicting a decryption mixer circuit. Because some of these Xor gates, e.g., 562, 570 and 572 in FIG. 18, 596 and 598 in FIG. 19 and 628 in FIG. 20 may have as many as six inputs, the actual implementation in hardware may involve short trees of narrower exclusive-or gates, either because direct implementation of such a high input gate is too complex or to reduce overall complexity by factoring common sub-expressions within or between multipliers. The exclusive-or function is fully commutative and this property can allow for the rearrangement of inputs. The logic for these six multipliers 365, 366, 422, 424, 426, and 428 is derived from the discussion of polynomial multiplication in the standards documents for Rijndael and AES and the tables of resulting values in the sample implementations, but the ultimate simplicity of their implementation functions according to the present invention is not shown in or suggested by those sources. The present invention can be seen to implement in simplified circuitry the modulo polynomial arithmetic operations required to implement a preferred embodiment of the present invention.

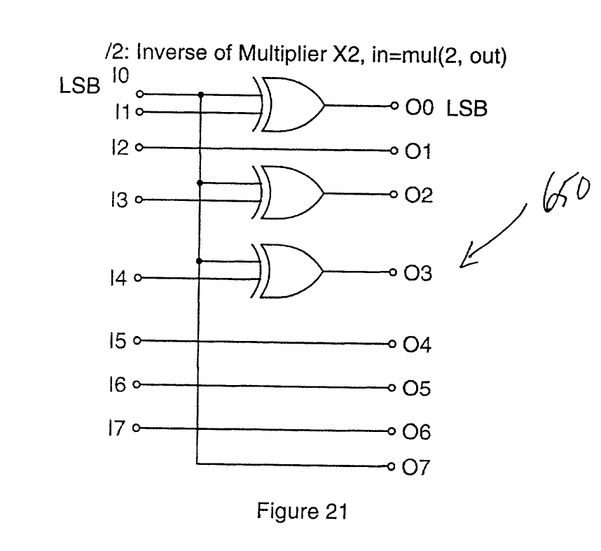

FIG. 21 shows a gate-level implementation 650 of what can be utilized to perform the inverse of multiplier x2 365, i.e., division by 2, denoted /2.

An implementation of a combined encryption and decryption pipeline can be desirable because of the high implementation cost of, e.g., the substitution tables. Because of the relative simplicity of the other functions in such a unidirectional pipeline, usually only a few exclusive-or gates per data line, keeping most of the logic for encryption and decryption separate can reduce the amount of multiplexing needed to combine the alternate logic. Rijmen discusses features of a design of a Rijndael encryption/decryption device that allow reordering some of the steps in a round permitting the same order of operations in the pipeline for both encryption and decryption. The extra complexity these techniques can add to the key expansion process can outweigh the complexity savings in a combined encryption/decryption pipeline. Every step of the pipeline is slightly different between encryption and decryption: key addition uses different bits from key expansion, a different substitution is applied, the shift is different, and the mixing functions are different. One of the changes can also require applying the mixing transformation to the expanded key used for decryption. Such a design can use two nearly independent pipelines that only share the S-boxes. Multiplexers can be used at the input to the shared S-boxes and can also be used at the very beginning and end of pipeline to connect the proper data to the S-boxes and the final output.

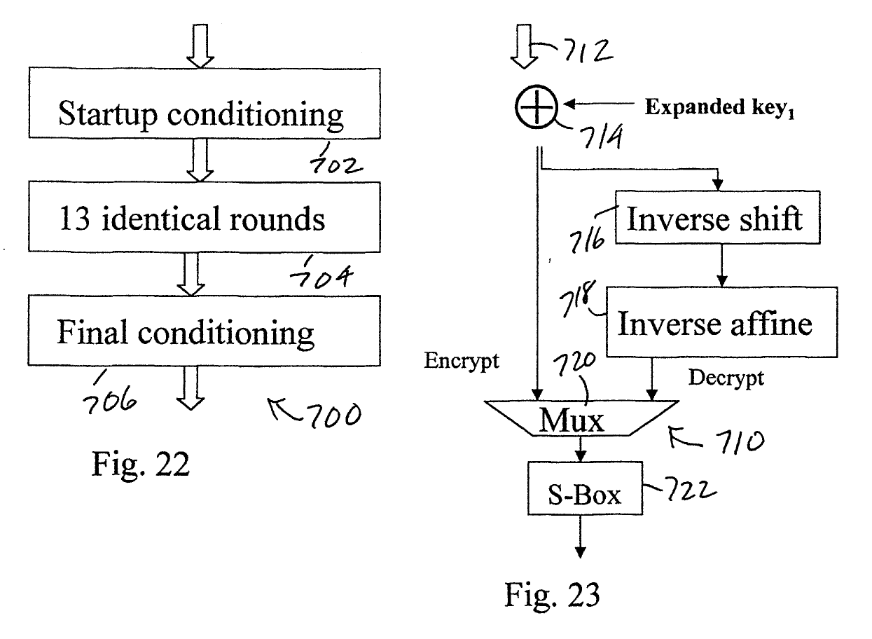

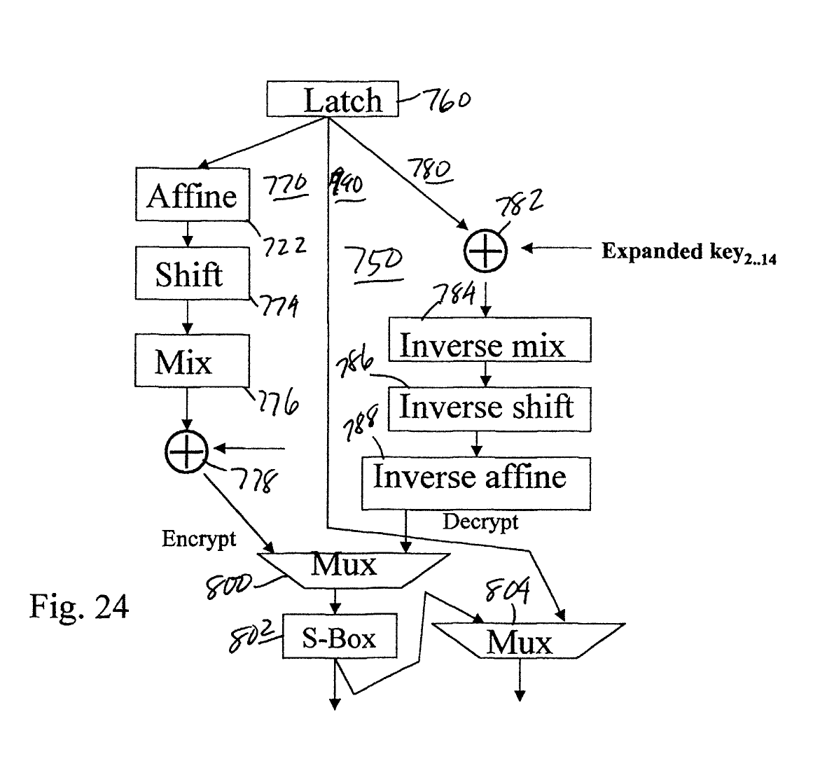

FIG.'s 22 through 25 illustrate what may be utilized as a round-wise implementation of a unidirectional encryption/decryption circuit. Note that a decryption path through the whole pipeline can exactly reverse the order of all the steps in the encryption pipeline, using the inverse of every transformation function. FIG. 22 shows an overview of a possible data pipeline 700. At the beginning and the end of the pipeline 700 the logic can be somewhat different than in the rest of the pipeline, e.g., in order to, e.g., mirror the start and end of the, e.g., AES processing algorithm. The pipeline 700 includes startup conditioning in box 702, a plurality of identical pipelined rounds 704, e.g., 13, and final conditioning in box 706. The circuitry provides for the fact that a number of rounds, e.g., some or all of the last four rounds in the rounds box 704 may be bypassed or skipped, as explained in more detail, e.g., in regard to FIG. 24, depending upon the length of the data block and the encryption key, upon which vary the number of rounds necessary.

FIG. 23 shows an example of an implementation of startup round 710 within the startup conditioning box 702 of FIG. 22. This startup round 710 can include an input data block 712, e.g., in the case of AES, of 128 bits in width. The input data block 712 can be exclusive-ored in an Xor gate array 714 with an expanded key for this round Expanded Key₁. The output of the Xor gate array 714 in this startup round can be passed directly to a 32 octet wide encrypt set of inputs to, e.g., a 64 octet wide multiplexer 720. The output of the Xor gate array 714 can be passed to, e.g., an inverse shift box 716 (the same one as 786 discussed below for decryption in regard to FIG. 24), the output of which can be passed to an inverse affine transformation circuit 718, which can be 786, the same one discussed as being used for decryption in FIG. 24. The output of shift box 716 can be passed to, e.g., a 32 octet wide decrypt set of inputs to the multiplexer 720. The output of the multiplexer 720 selected by whether the pipeline is in encrypt mode or decrypt mode, i.e., respectively, from the Xor gate array 714 output or the inverse affine transformation circuit 718, and can be passed, e.g., to an S-Box look up table 722.

FIG. 24 shows an exemplary implementation of the flow of data through any of, e.g., the intermediate rounds in box 704 of FIG. 22. Each round 750 can begin with an optional inter-stage data latch 760. These inter-stage latches 760 can be an important feature in a high throughput pipeline. The time it takes for the logical operations to propagate through the rounds logic 750 from one inter-stage latch 760 to the next sets the upper bound on the pipeline clock rate for introducing new data into the pipeline 700. The total number of inter-stage latches 760 along the pipeline 700 can also determine the maximum number of encryption/decryption operations that are simultaneously in the pipeline 700. The number of inter-stage latches 760 also can affect the total delay between the start and end of the encryption or decryption of a single block, since introducing the inter-stage latches 760 adds additional setup and hold timing requirements on the inter-stage latch 760 input plus the propagation delay in the inter-stage latch 760. After the latch 760, the input data block, e.g., in AES, of 128 bits in width can flows through, e.g., three pathways.

The left pathway, as shown in FIG. 24, 770 can be utilized to handle encryption. The left pathway 770 can include an affine transformation circuit 772, e.g., as shown in FIG. 6, a shift logic circuit 774, e.g., one of those as shown in FIG.'s 7-10, i.e., FIG. 7 for AES, FIG. 8 and FIG. 9 for other fixed widths, and FIG. 10 for Rijndael. In the case of the circuit shown in FIG. 7, as enumerated in the encryption column labeled 128-bit of Table 2, a mixing logic circuit 776, e.g., as shown in FIG. 13, and finally an exclusive-or gate array with, e.g., the proper segment of the expanded key Expanded Key_{2 . . . 14} for the given round, as shown, e.g., in FIG. 2.

The right pathway 780 can be utilized to handle decryption. The right pathway can include an exclusive-or gate array 782 with the expanded key for the respective round, Expanded Key_{2 . . . 14}, the output of which can be passed to an inverse mixer circuit 784, as shown, e.g., in FIG. 14, an inverse shift logic circuit 786, e.g., as shown in FIG.'s 7-9 or 11, and likewise in FIG.'s 8 and 9 for wider fixed widths or FIG. 11 for Rijndael with support for multiple block sizes, and finally an inverse affine transformation circuit, e.g., as shown in FIG. 5. At this point the left and right data paths can be selected, e.g., with multiplexer 800, to pass data resulting from the current encryption or decryption mode of operation to, e.g., S-Boxes 802. There can be, e.g., one S-Box 802 for each 8 bits of data in the data block, e.g., 16 S-Boxes 892 for AES. These S-Boxes 802, as explained above, can be lookup tables containing, e.g., the entries in Table 1 such that for every value of the input eight bit octet there is an output eight bit octet obtained from the S-Box, which can be implemented as a read-only memory. The output of the S-Boxes 802 can form the input into the next round, e.g., into an inter-stage latch 760 for the next stage or directly into three paths of the next stage. The output of the S-Boxes 802 can also provide an input into the multiplexer 804, which can also receive the data block from the prior round unmodified, as explained below in regard to the middle path 790.

A middle path 790 can be provided to handle the cases when the round logic 750 has to be skipped. Skipping is used as needed to get the proper total number of rounds based on the length of the encryption key and the data block. In general only a few stages will actually need to implement the logic for skipping—generally four for a full 14-round linear pipeline, and one or two for a shorter pipeline, as explained above. The middle path 790 and multiplexer 804 may be omitted when a round does not need to perform the skip function.

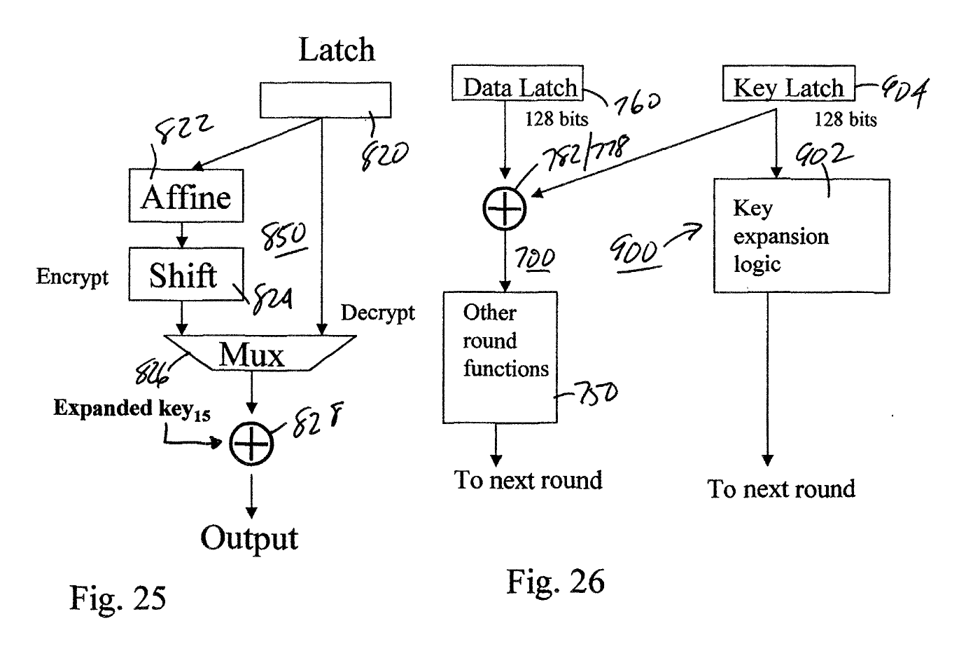

FIG. 25 shows an example of an implementation of final processing circuit, e.g., in box 706 of FIG. 22. This circuit can include an optional latch 820, an affine transformation circuit 822, the output of which can be passed to a shift circuit 824 (the same as 774, discussed above in regard to FIG. 24), the output of which is the encryption path 840 input into a multiplexer 826, and a decryption input 850 into the multiplexer 826. The output of the multiplexer 826 can be passed to Xor circuit 828 and Xor'ed with the Expanded Key for the output stage, Expanded Key₁₅.

For full Rijndael, the overall structure of the rounds can be identical to that just described in regard to FIG.'s 22-25, however, the pipeline may need to be wide enough to handle 256-bit data and the shift logic may depend on data widths, e.g., as shown in regard to FIG. 10 (encryption) or FIG. 11 (decryption), and, e.g., as enumerated in Table 2. Twice as many S-Boxes may also be required to handle potentially expanded data blocks of up to 256 bits.

AES and Rijndael both expand the input key to provide key addition bits used in the startup round, Expanded Key₁, used in each round Expanded Key₂-₁₄, and in a final addition Expanded Key₁₅. There are at least two possible alternatives for supplying this Expanded Key_{1, . . . 15} to the encryption/decryption pipeline 700. One possibility is to store the entire expanded key (up to 1920 bits for AES, up to 3840 for Rijndael). The logic to perform the expansion could be implemented inside or outside the encryption unit. In this case, speed in performing key expansion may not be critical since it is only done when a new session is established or re-keyed. An alternative can be to store the actual key (encrypt) or a key-sized snapshot of the expanded key as seen at the end of encryption for the decryption process, e.g., because it uses the last bits of the expanded key first, and the first bits last. The decryption key addition operation may use exactly the same expanded key bits as encryption, but may use them in the reverse sequence. The very first key addition step in decryption may use the same sequence of bits as were used in, e.g., the final key addition of the corresponding encryption. Decryption may then step backwards through the expanded key until the final addition, e.g., utilizing the same value as the first addition during encryption. Because key expansion also uses reversible operations, it is possible, e.g., to compute in reverse to work back from the final stage of key expansion, Expanded Key15 to the original key, computing in reverse the round Expanded Keys 1-14 in the process.

Pipelined key expansion was suggested during the adoption of the AES standard, e.g., in Weeks, et al., noted above. When a key is expanded on the fly in parallel with encryption or decryption, it can add about 25% additional logic to the pipeline, mostly for additional S-Boxes. The gate count to implement a full-length key expansion pipeline could be comparable to memory for about 64 pre-expanded keys, or fewer for a shorter, looping pipeline. If the intended application could simultaneously use more than that many keys, pipelined key expansion can lower the total gate count. In a pipelined implementation, it can be essential to perform key expansion at about the same speed as expanded key bits are used in the encryption process.

A key expansion cycle may compute a block of key bits from the previous block, where each block is the size of the input key. For 128-bit and 192-bit keys, this process can require four S-Boxes and a number of exclusive-or gate arrays. Expanding a 256-bit key can require eight S-Boxes and exclusive-or gates arrays. When processing 128-bit data blocks, the expansion of a 256-bit key can be split between two successive rounds in a way that only requires four S-Boxes in each round. [claims] For AES, this means only four S-Boxes per round may be needed for key expansion regardless of key length. A full Rijndael implementation would still require the eight S-Boxes per round to handle all key expansion cases, but because the data pipeline also needs to be twice as wide, the key expansion overhead remains near 25%.

The process of key expansion can vary with both encryption key length and encryption mode versus decryption mode. For a full Rijndael implementation, additional complexity can derive from the variable data block size. Some rounds may, e.g., require key expansion to be performed twice to supply enough bits when the data block is longer than the key. At the beginning of a pipeline for encryption, the key can be presented in parallel with the data block. For decryption, the initial “key” is not the standard AES or Rijndael key, but the key as it appears as the output of the last stage of the key pipeline during encryption. This initial value could be computed by external control software or by additional circuitry in the device to perform the expansion or capture the output of the main key expansion pipeline in a special calibration cycle. Because keys change relatively infrequently, this process may not affect performance significantly.

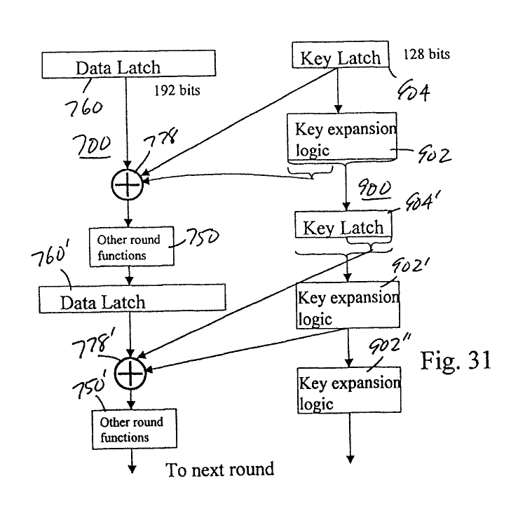

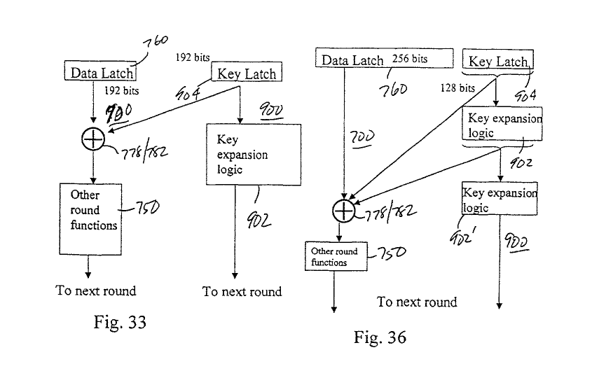

FIGS. 26 through 39 show examples of implementations of a flow of key bits to the key addition step in the data pipeline and in parallel to the key expansion logic. Each figure shows a different case that can depend upon the length of the data block and the length of the key inputs and encryption mode or decryption mode. Tables 3, 4 and 5 below detail examples of the routing of bits from a key latch 904 in FIG. 26, and from the results of key expansion in key expansion logic 902 to the proper segment of the data for the key expansion function 900. FIGS. 31 through 39 and tables 4 and 5 could apply only to Rijndael, when the data block is longer than 128 bits, while FIGS. 26 through 30 and table 3 could apply to both AES and Rijndael for 128-bit data blocks. FIG. 26 shows an example of an implementation of the case for AES where both the data and key are 128 bits long, in which the overall data flow can be essentially the same for encryption and decryption. In FIG. 26, the input key can be routed from an optional key latch 904 directly to both the key addition logic 778/782 and the key expansion logic 902 in parallel. The output of the key expansion logic 902 can be passed to the next round for the next cycle of key addition and expansion. FIGS. 33 and 39 may apply to Rijndael only, but are very similar is structure because they are also cases where the key and data are the same length, 192-bit and 256-bit lengths respectively. The remainder of the FIG.'s relevant to AES, 27 through 30 are examples of implementations of cases where the key is longer than the 128-bit data block, so the key expansion process may need to be skipped in some stages in order to keep the production and consumption of the Expanded Key . . . synchronized.

In all of the implementations illustrated in FIG. 's 26 through 39, where, e.g., key addition uses bits from both the key input and the result of key expansion, the ordering of the bits from the two sources can be systematic. For encryption, the selected bits of the input key can be the leftmost bits to the key addition function, and if additional bits come from the output of key expansion, the required number of bits from the left end of the expansion output can be used as the input to the right portion of the key addition function. In decryption, the portion of the input key used for key addition can be the rightmost bits of the key value, and the necessary number of bits from the right end of the result of the first key expansion can be used to fill the left part. Since 64 is the greatest common divisor of all possible lengths of keys and data, segments of keys may be limited to some multiple of 64 bits in length and offset.

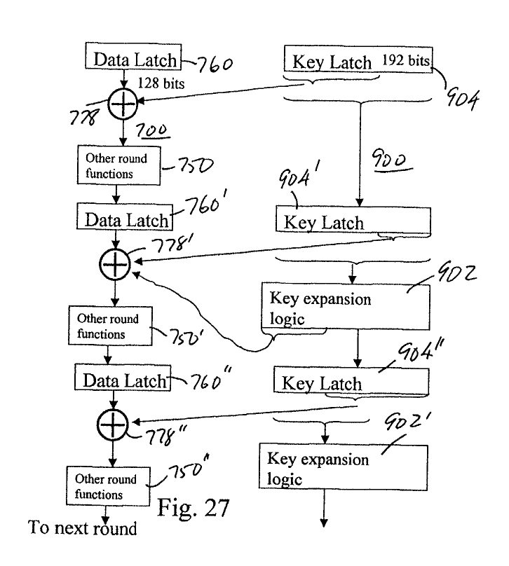

FIG. 27 shows an example of an implementation of circuitry for carrying out, e.g., three consecutive rounds, e.g., when a 192-bit key is used for encryption in AES with a 128 bit data block. Because 128 times 3 equals 192 times 2, key expansion may need to be performed only two of every three rounds. In the first round, the left 128 bits of the key in the key latch 904 can be used for key addition in Xor gate array 778 and all 192 bits of the key can pass unchanged to the next round. In the second round, the previously unused 64 bits of the key now present in key latch 904′ can be used for the left half of the key provided for key addition in Xor gate array 778′, and the first 64 bits from the output of key expansion in box 902 can be used for the other half. The entire output of key expansion in box 902 can then be passed to the third round key latch 904″. In the third round, the remaining 128 bits from the expanded key in key latch 904″ can be used for key addition in Xor gate array 778″ and the entire expanded key in key latch 904″ can by again expanded in key expansion logic 902′ for the following stage of the next round. From the fourth round on, as shown in FIG. 27, this pattern can be repeated. The second round is an example of worst case timing in AES for the combined key and data pipelines since the key addition in Xor gate array 778′ depends on the completion of an expansion cycle in key expansion box 902. It could be possible to eliminate this delay by offsetting the key pipeline 900 to one round earlier than the data pipeline 700. This could slightly add to the complexity because additional latches would be needed, e.g., to hold the prior stage key, e.g., as contained in key latch 904 as well as the current stage round key, as contained, e.g., in key latch 904′. It could also add, e.g., an extra stage to the front of the pipeline 700, 900, however, the time in the extra stage could be offset by the reduced delays in the following rounds.

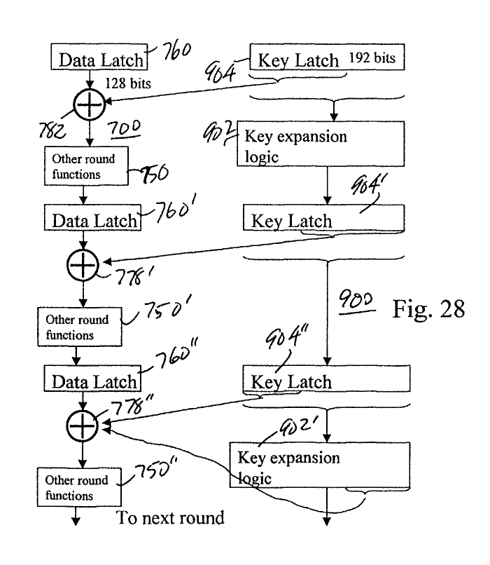

FIG. 28 shows an example of an implementation of AES 192-bit key decryption. Again, there may be, e.g., only two expansions in every three rounds, however, the round that skips expansion is now the middle of three rounds, and the bits may be used right to left. In the first round the leftmost 128 bits of the key in key latch 904 may be used for key addition in Xor gate array 782. The rightmost 64 bits of the initial key in the key latch 904 may be excluded from key addition because they are in excess of the total number of expanded key bits needed. 13 key additions of 128 bits may require the original key plus 8 expansions of the 192-bit key, resulting in 64 unneeded bits. In the subsequent repeats of the 3-round pattern, these 64 bits may have been used in the respective prior round. The key may also be expanded in box 902 for use in the next round. In the second round, the rightmost 128 bits of the incoming key in key latch 904′ may be used, and the key in key latch 904′ may also be passed through unmodified to the key latch 904″ in the next round. In the third round, the right 64 bits for key addition come from the leftmost 64 bits of the key in key latch 904′ and the left half is taken from the rightmost 64-bits of the result of key expansion in block 902′. Starting with the fourth round, the pattern can be repeated.

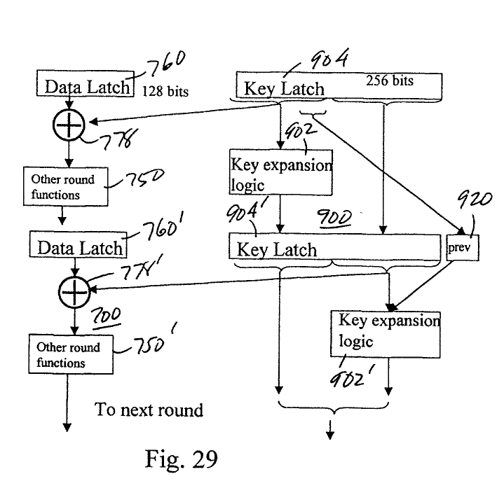

FIG. 29 diagrams an example of an implementation of the flow of key expansion for a 256-bit key in AES encryption. In this case, e.g., each 128 bit segment of the key contained in key latch 904 can be sufficient to supply, e.g., the necessary 128 key addition bits to Xor gate arrays 778, 778′ for two successive rounds, and logically the expansion of the key only needs to be performed, e.g., in alternating rounds. However the expansion of a 256-bit key can require a large amount of additional memory, e.g., to implement eight S-Boxes rather than the four needed to expand shorter keys. Because the gate count for each S-Box is quite high it is desirable to minimize the overall number employed (consistent with throughput requirements). The expansion operation on a 256-bit key can have only limited information flow between the two halves of the key. Therefore, the expansion can be divided between two consecutive rounds without introducing any extra delays. Segmenting the expansion can require, however adding an extra 32-bit latch 920 between, e.g., the odd and even round to save the original key in bit positions 97 through 128 in the key latch 904, in order for the expansion logic circuit 902′ to implement the expansion of the right most 128 bits in the key latch 904′ according to the key expansion algorithm of Section 5.2 of the AES Rijndael Standard.

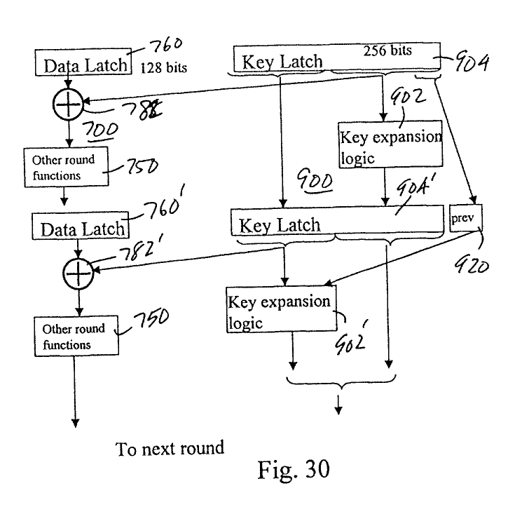

FIG. 30 shows an example of an implementation of key expansion during decryption, e.g., in AES for a 256-bit key. Once again, the expansion process is split into two halves but in decryption, the right half of the key is expanded first in expansion logic circuit 902 and the left half is expanded in the following round in expansion logic circuit 902′. Similarly the rightmost 32 bits of the key contained in the first round key latch 904 has to be saved in supplemental latch 920 to provide the proper information to the other half of the expansion in box 902′.

In half of the Rijndael-only variants of the algorithm, the data block may be longer that the key, and to match the rate of expanded key production to use in key addition, some rounds may have to perform two cycles of key expansion within a single round. When a 256-bit data block is combined with a 256-bit key, it may require a full key expansion on every round, and this case can require eight S-Boxes in the key expansion pipeline. In cases where the key is shorter than the data block, key expansion may require only four S-Boxes per expansion. With the proper multiplexing of inputs to the S-Boxes, the same eight S-Boxes can be sufficient for any possible combination of double expansion when required as well as a full 256-bit key expansion. Rounds that perform two key expansions may be selected to satisfy two conditions. The first condition may be that a second key expansion is not done so early that both the key and the expansion are needed in more than one round. This can minimize the number of key latch bits required between stages. The second condition can be that the result of the second key expansion is never used for key addition in the stage in which it is computed. This can help limit the delays to the data portion of the pipeline and allow parallelism between the second expansion and most of the data pipeline functions. Nevertheless, the time to perform two consecutive key expansions may well be the limiting factor in the maximum clock speed for an encryption/decryption pipeline.

FIG. 31 illustrates a possible implementation of a case for Rijndael where, e.g., a 192-bit data block is encrypted with a 128-bit key. Because the key as, e.g., contained in key latch 904 in FIG. 31, is only two thirds the size of the data block, as contained, e.g., in data latch 760 in FIG. 31, every other round may require performing two key expansions to supply enough bits for key addition in the respective Xor gate array circuits, 778, 778′. In, e.g., the odd numbered rounds, the key addition in, e.g., Xor gate array circuit 778 can use the input key from the key latch 904 as the first 128 bits and the left half of the result of key expansion in key expansion logic circuit 902 as the other 64 bits. In, e.g., the even numbered rounds, the right half of the incoming key contained in key latch 904′ can form the left third of the key addition value and the result of a first key expansion in key expansion logic circuit 904′ can provide the remainder to Xor gate array circuit 778′. During this round associated with Xor gate array circuit 778′, there can also be performed a second expansion of the output of the key expansion logic circuit 902′ in key expansion logic circuit 902″ to provide the key to the next round.

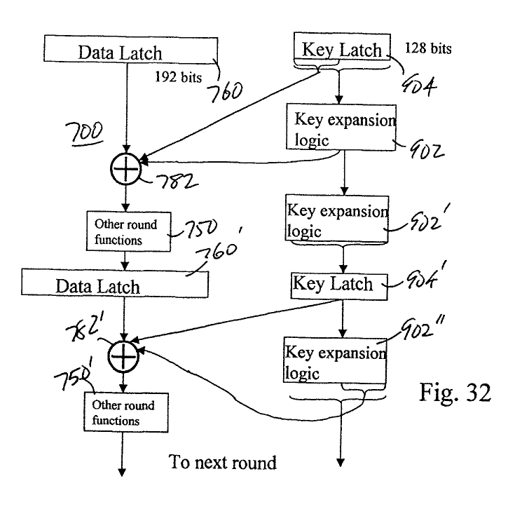

FIG. 32 shows an implementation of the decryption case corresponding to FIG. 31. In this case the extra expansion can occur, e.g., in the odd numbered rounds. In the odd numbered round, the left two thirds of the input to the key addition on Xor gate array circuit 782 can come from key expansion in key expansion logic circuit 902 and the right third can consist of the left half of the input key as contained, e.g., in key latch 904. In, e.g., the even round, the input key to Xor gate array circuit 782′ can come from the key latch 904′ in FIG. 32 and the other third can come from the right half of the key expansion output of key expansion logic circuit 902″. The additional key expansion logic circuit 902′ in this case can be between the key expansion logic circuit 902 and the key latch 904′.

FIG. 33 shows a possible implementation of a straightforward situation in Rijndael when both the data block and key block are 192 bits. In every round the input key as contained, e.g., in key latch 904 can be used both for key addition in Xor gate array circuit 778,782, respectively for encryption and decryption, and as input to the key expansion function in key expansion logic circuit 902.

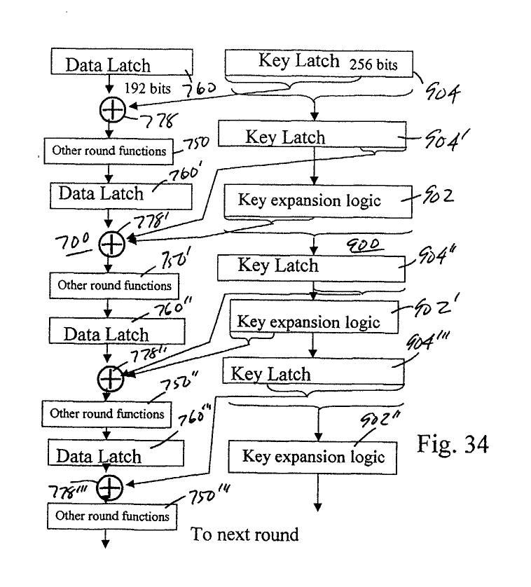

FIG.'s 34 and 35 show possible implementations of the arrangement for encryption and decryption when a 256-bit key, as contained, e.g., in key latch 904 in FIG. 34, is used in Rijndael for a 192-bit data block, as contained, e.g., in data block latch 760, as shown in FIG. 34. In this case, only three key expansions may be needed to be performed every four rounds. For encryption, as illustrated in the example of FIG. 34, the first round of each four can skip key expansion. In the first round, e.g., the leftmost 192 bits of the key contained in key latch 904 can be used for key addition in the round Xor gate array circuit 778. In the second round, 64 bits for the key addition input to the second round Xor gate array circuit 778′ may come from the right end of the key contained in key latch 904′ and 128 bits may come from the output of the expansion of the key in key expansion logic circuit 902 in FIG. 34. The third round the key addition in Xor gate array circuit 778″ can use the right half of the key as contained in key latch 904″ in FIG. 34 plus the first 64 bits from expansion of the key in key expansion logic circuit 902′. In the fourth round, e.g., all 192 bits for key addition in the round Xor gate array circuit 778′″ can come from the right end of the input key contained in key latch 904′″. The content of the key latch 904′″ may then be expanded in key expansion logic circuit 902″ to form the key for the next successive round.

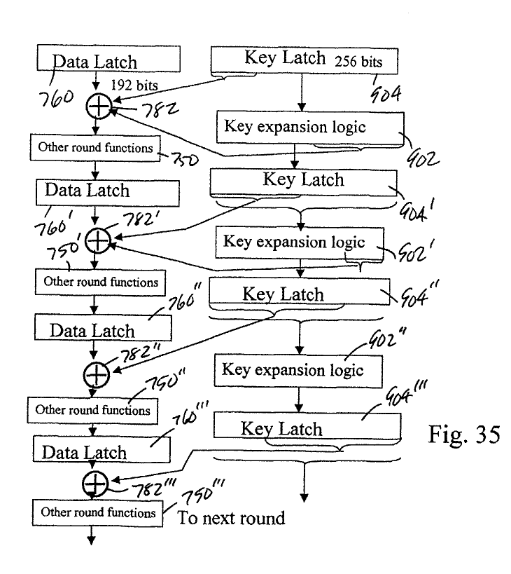

For decryption, as illustrated in the possible embodiment shown in FIG. 35, the last round of every four can be the one that skips expansion. In the first round, the key for key addition in the round Xor gate array circuit 782 of FIG. 35 may come from, e.g., the right half of the key expansion output of key expansion logic circuit 902 and the first 64 bits of the input key as contained, e.g., in key latch 904 in FIG. 35. In the second stage, the last 64 bits of the expansion output of the key expansion logic circuit 902 and the left half of the key as contained, e.g., in key latch 904′ can be used for key addition in the round Xor gate array circuit 782′. In the third round the leftmost 192 bits of the input key as contained, e.g., in key latch 904″ can be used for addition in the round Xor gate array circuit 782″. In the forth round, the rightmost 192 bits of the input key as contained in key latch 904′″ may be used for addition for key addition in the round Xor gate array circuit 782′″. Key expansion can occur on the content of key latch 904″ in key expansion logic circuit 902″ to form the input to the key latch 904′″

FIG. 36 shows an example of an implementation of the case in Rijndael where a 128-bit key is used for encryption or decryption of a 256-bit data block. In this case, two key expansions can be required in every round, and the input key as contained in, e.g., key latch 904 can be used for half of the input to the key addition in the round Xor gate array circuit 778, 782, respectively for encryption and decryption, and the output of the first expansion in key expansion logic circuit 902 can be used for the other half. The output of the key expansion logic circuit 902 can be passed to key expansion logic circuit 902′ in FIG. 36, the expansion output of which is the input to the next round. Following the general guideline, the input key can be used as the left half in encryption and the right half in decryption. Each expansion can require 4 S-Boxes for a total of 8 per round.

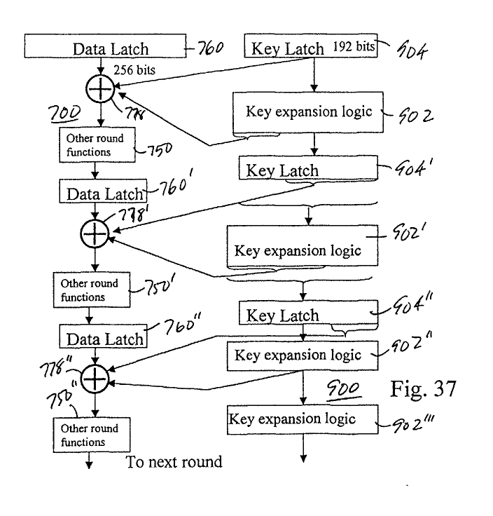

FIG.'s 37 and 38 show examples of possible implementations for the cases with a 256-bit data block and a 192-bit key. To match key expansion to use, these cases can require four expansions for every three rounds, and the extra expansion may be selected to occur in, e.g., the third round. An example of the encryption embodiment is shown in FIG. 37. In the first round, the entire input key as contained, e.g., in key latch 904 can be the left 192 bits used in key addition in the round Xor gate array circuit 778, with the remaining 64 bits being taken, e.g., from the left end of the output of key expansion in key expansion logic circuit 902 in FIG. 37. In the next round, the left half of the key addition bits input into the key addition in the round Xor gate array circuit 778′ may come from the rightmost 128 bits of the input key as contained in key latch 904′ and the other half may come from, e.g., the leftmost 128 bits from key expansion in key expansion logic circuit 902″. In the third round, the left 64 bits for key addition in the round Xor gate array circuit 778″ may come from the last 64 bits of the input key as contained in key latch 904′ and the remainder can be, e.g., the output of the expansion in key expansion logic circuit 902″. A third expansion in key expansion logic circuit 902′″ in FIG. 37 can provide the key passed on to the next round.

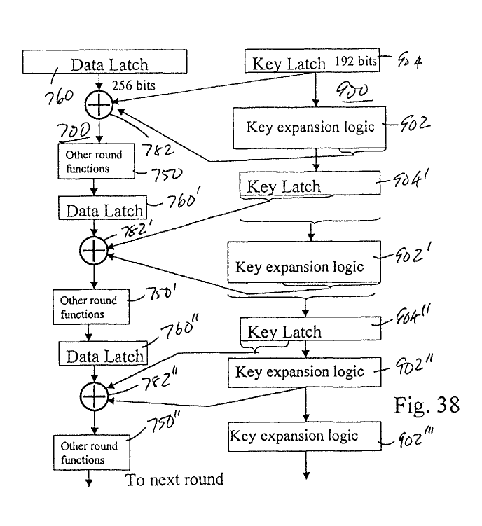

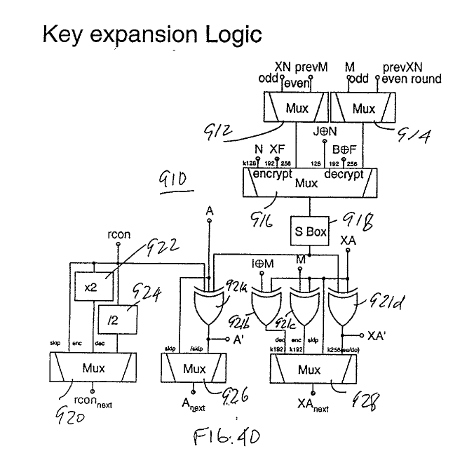

Decryption, as exemplified in FIG. 38 for the same case as in FIG. 37 is very similar, with, e.g., the same number of bits from the key input and expansion output used in every round, however the bits may be taken from the left end of the key for the right portion of key addition and from the right end of the output of key expansion for the left end of the input to key addition.

FIG. 39 shows an example of an implementation of the straightforward situation in Rijndael when both the data block and key block are 256 bits. In every round the input key as contained, e.g., in key latch 904 can be used both for key addition in the round Xor gate array circuit 778, 782, respectively for encryption and decryption and as the input to the key expansion function in key expansion logic circuit 902. Note that the key expansion operation can takes eight S-Boxes on each round, but the expansion operation can be done in parallel with the encryption activity.

Because of the variations in key expansion with key length and encryption versus decryption, multiplexing may be required to route the proper bits from the key expansion pipeline 900 to the bits in the encryption and decryption pipeline 700. Because all of the lengths are multiples of 64, there are usually only three or four sources of a key bit for each data bit, decided in parallel for each block of 64 data bits. Possible sources are one of the 64-bit segments of the key (of which there may be two, three or four, depending on key length) or one of three 64-bit segments from, e.g., the output of the expansion process. Only three are actually possible since the fourth is always needed for addition from the key input. The full Rijndael algorithm adds more variations, but can be similar in overall structure. Table 3 below summaries the possibilities for AES. An entry in the body of the table labeled key denotes a portion of the key input to the round. Entries marked expansion indicate, e.g., the selection the output of the key expansion logic in the current round. Pipeline length can affect the number of real cases needed in a round. With a 14-round pipeline, e.g., some sources may never actually be used in one or another of the rounds. At the other extreme, e.g., a single hardware round used iteratively may have to support every possibility in Table 3. Pipelines three or six rounds long may, e.g., align much of the data routing between iterations. For example, in a full pipeline or a six-round pipeline, the first round in the pipeline may always use, e.g., the first 16 octets of the key in order to combine with the 16 data octets and no multiplexing at all may be required in the stage. In the case of, e.g., a six round pipeline, this may be because the data source is the same in rounds, e.g., 1, 7 and 13, all employ, e.g., the first round logic on successive trips through the pipeline. Tables 4 and 5 below are for the full Rijndael where the data block length can also be 192 or 256.

TABLE 3
AES key addition source (Rijndael 128-bit data)

| Data octets | 128-bit key | → | 192-bit key | ← | 256-bit key | ← |
|---|---|---|---|---|---|---|
| Round nr. | any | 1, 4, 7, 10, 13 | 2, 5, 8, 11, 14 | 3, 6, 9, 12, 15 | odd | even |

Encryption

| | | | | | | |
|---|---|---|---|---|---|---|
| 1-8 | key 1-8 | key 1-8 | key 17-24 | key 9-16 | key 1-8 | key 17-24 |
| 9-16 | key 9-16 | key 9-16 | expansion 1-8 | key 17-24 | key 9-16 | key 25-32 |
| Skip | | yes | | | Right half | Left half |
| expansion? | | | | | | |

Decryption

| | | | | | | |
|---|---|---|---|---|---|---|
| 1-8 | key 1-8 | key 1-8 | key 9-16 | expansion 17- | key 9-16 | key 1-8 |
| | | | | 24 | | |
| 9-16 | key 9-16 | key 9-16 | Key 17-24 | key 1-8 | key 25-32 | key 9-16 |
| Skip | | | yes | | Left half | Right half |
| expansion? | | | | | | |

TABLE 4
Rijndael key addition source, 192-bit data

| Data octets | 128-bit key | ← | 192-bit key | → | 256-bit key | ← | ← |
|---|---|---|---|---|---|---|---|
| Round nr. | odd | even | any | 1, 5, 9, 13 | 2, 6, 10, 14 | 3, 7, 11, 15 | 4, 8, 12 |

Encryption

| | | | | | | | |
|---|---|---|---|---|---|---|---|
| 1-8 | key 1-8 | key 9-16 | key 1-8 | key 1-8 | key 25-32 | key 17-24 | key 9-16 |
| 9-16 | key 9-16 | expansion | key 9-16 | key 9-16 | expansion | key 25-32 | key 17-24 |
| | | 1-8 | | | 1-8 | | |
| 17-24 | expansion | expansion | Key 17-24 | Key 17-24 | expansion | expansion | key 25-32 |
| | 1-8 | 9-16 | | | 9-16 | 1-8 | |
| Expansion | 1 | 2 | 1 | none | 1 | 1 | 1 |
| skip | | | | | | | |

Decryption

| | | | | | | | |
|---|---|---|---|---|---|---|---|
| 1-8 | expansion | expansion | key 1-8 | expansion | expansion | key 1-8 | key 9-16 |
| | 1-8 | 9-16 | | 17-24 | 25-32 | | |
| 9-16 | expansion | key 1-8 | Key 9-16 | expansion | key 1-8 | key 9-16 | key 17-24 |
| | 9-16 | | | 25-32 | | | |
| 17-24 | key 1-8 | key 9-16 | Key 17-24 | Key 1-8 | Key 9-16 | key 17-24 | key 25-32 |
| Expansion | 2 | 1 | 1 | 1 | 1 | 1 | none |
| skip | | | | | | | |

TABLE 5
Rijndael key addition source, 256 bit data

| Data octets | 128-bit key | → | 192-bit key | ← | 256-bit key |
|---|---|---|---|---|---|
| Round nr. | any | 1, 4, 7, 10, 13 | 2, 5, 8, 11, 14 | 3, 6, 9, 12, 15 | any |

Encryption

| | | | | | |
|---|---|---|---|---|---|
| 1-8 | key 1-8 | key 1-8 | key 9-16 | key 17-24 | key 1-8 |
| 9-16 | key 9-16 | key 9-16 | key 17-24 | expansion 1-8 | key 9-16 |
| 17-24 | expansion | key 17-24 | expansion 1-8 | expansion | key 17-24 |
| | 1-8 | | | 9-16 | |
| 25-32 | expansion | expansion | expansion | expansion | key 25-32 |
| | 9-16 | 1-8 | 9-16 | 17-24 | |
| Expansions | 2 | 1 | 1 | 2 | 1 |

Decryption

| | | | | | |
|---|---|---|---|---|---|
| 1-8 | expansion | expansion | expansion | expansion 1-8 | key 1-8 |
| | 1-8 | 17-24 | 9-16 | | |
| 9-16 | expansion | key 1-8 | expansion | expansion | key 9-16 |
| | 9-16 | | 17-24 | 9-16 | |
| 17-24 | key 1-8 | key 9-16 | key 1-8 | expansion | key 17-24 |
| | | | | 17-24 | |
| 25-32 | key 9-16 | key 17-24 | key 9-16 | key 1-8 | key 25-32 |
| Expansions | 2 | 1 | 1 | 2 | 1 |

The logic required to implement one round of the key expansion pipeline. Turning now to FIG.'s 40-42 there is shown an example of an implementation of a portion of a logic circuit for key expansion in, e.g., an AES-only pipeline with a fixed 128-bit data block size and a variable key length. FIG.'s 43-45 show an example of an implementation of the corresponding circuitry for a full Rijndael implementation with, e.g., a variable data width as well as variable key length. In all of these figures, the lines connecting logic elements can represent 8-bit data paths carrying, e.g., one octet of the key and its expansion or various intermediate values. The control signals required for the multiplexers are not explicitly shown in the diagrams, and in an actual integrated circuit hardware instantiation some of the multiplexers may be omitted or simplified because their control input could be a constant. For example, a number of multiplexers are gated depending on whether a round is even numbered or odd numbered. When, e.g., the implementation involves unrolling the rounds iteration into a full 14-round linear pipeline, one or more stages of the pipeline may perform a fixed round number, as opposed to alternating even and odd. The first stage in the pipeline, also for example, may always be treated as an odd-numbered round, not an even one. In, e.g., a partially linear partially iterative realization, the choice of pipeline length may be partially influenced by such a design choice. As an example, a pipeline length of two or six rounds could simplify the multiplexing for both key expansion and the routing of key bits to the key addition operations. At the other extreme, e.g., a fully iterative implementation with only a single round in hardware may need every multiplexer shown as well as, e.g., a round counter as part of the control logic for the multiplexers. Limited implementations of AES and Rijndael are possible that can omit some of the possible combinations of data and key lengths. In such limited implementations, e.g., the key expansion logic may be simplified by, e.g., pruning gates and multiplexers for the unimplemented cases.

Several logical operations are used in FIG.'s 40-45. The boxes labeled Mux are multiplexers where the output is whatever is on the single chosen input, which as are shown may depend, e.g., on such variables as whether the round is even or odd, whether the key is 128, 192 of 256, whether the data block is 128, 192, or 256 (for FIG.'s 43-45), whether the mode is encryption or decryption or skip, etc. The boxes labeled S-Box implement the S-Box substitution shown in the table in FIG. 8 of the Federal AES Standard. Because decryption does NOT use the inverse substitution function required on the data portion of the pipeline, this is a very efficient realization of S-Boxes dedicated to key expansion. The table of FIG. 8 of the Federal AES Standard is equivalent to the substitution values in Table 1 above, followed by the affine transformation as shown, e.g., in FIG. 6. However, this would only be helpful in a slow, minimal gate count system where a small number of S-Boxes can be used repeatedly. The boxes labeled x2 implement the polynomial multiplication, e.g., a shown in FIG. 15, and the boxes labeled /2 are the inverse function, e.g., as shown in FIG. 21. The exclusive-or symbols used throughout this series of figures denote eight parallel exclusive-or gates, one for each of the eight bits in the implied octets.

For the purpose of the AES key expansion pipeline, the inputs, outputs and some intermediate values are named according to the following scheme. The octets of the key input to a round are labeled in order A, B, C, D, E, F, G, H, I, J, K, L, M, N, O, P, XA, XB, XC, XD, XE, XF, XG, XH, XI, XJ, XK, XL, XM, XN, XO and XP. When, e.g., the key is only 128 bits long, only, e.g., octets A through P are used and a 192-bit key, e.g., uses A through P and XA through XH. With short keys, the inputs to the other octets may be any convenient value, as they will not affect the output. The output to the following round is marked with the same letter code and the subscript next. An apostrophe (e.g. A′) labels the output of some exclusive-or gates where the base label and the output of an S-Box are inputs, and a double apostrophe (e.g., A″) is used to label the output of an exclusive-or gate with an input of a primed value and the output of an S-Box. The label x⊕y is used on some exclusive-or gates with inputs x and y. Other figures use these labels as inputs to be taken from the corresponding output. The even inputs to some multiplexers have labels like prevM, which is the value of octet M presented as input to the preceding (odd-numbered) round. Only octets M, N, O, P, XM, XN, XO and XP are used in this way. In most cases, additional latches may be employed between rounds to save values, e.g., for the even stage. Rcon is an additional octet specified as part of the key expansion algorithm. The standard gives a table of values of rcon to use for each expansion step, the sequence of values for rcon can be computable, e.g., by applying the same x2 function used in the mixing stage of the encryption algorithm to the preceding entry in the table. At the beginning of encryption, the value of rcon is an octet with binary value 1. For decryption, the initial value of rcon is the value that would be used in the last key expansion step during encryption. The proper initial value depends, e.g., on the key and data length because together these can determine the number of key expansion cycles required. The /2 function is the inverse of the x2 function. In implementations supporting only a single key size and a single data block size it could be possible to hardwire the proper value for each key expansion, but in all other cases the simplest implementation is, e.g., to derive the next value of rcon in synchronization with the process of key expansion.

The multiplexer inputs are labeled with the condition that selects a particular input. Even and odd are selected if the current round number is even or odd respectively. Encrypt or enc label inputs for encryption and decrypt or dec label inputs for decryption. Inputs labeled k128, 192 and 256 indicate the key length in bits, and in the Rijndael version, D128, D192 and D256 refer to the data block length. Ee/do specifies even round encryption or odd round decryption. If there are multiple labels on an input, all must be true for that input to be selected. The final output multiplexers also have an input labeled skip. The skip input is selected on those rounds where no key expansion is done. Most of the time this can be true are for those rounds, e.g., without key expansion as diagramed in FIG.'s 27, 28, 34 and 35, and in FIG.'s 29 and 30 for, e.g., the half of the key not being expanded. Key expansion may also be skipped in the last few rounds when the proper number of rounds has already been performed. As an example, with a 128-bit key and 128 bit data only 10 rounds may be used, but a general purpose pipeline needs to be able to implement, e.g., 14 rounds for the 256-bit cases.

The examples of the full Rijndael key expansion logic for any single round is more complex than for AES because of the larger number of cases, but the overall structure is similar. The labeling of the octets in the key is slightly different to emphasize the relationship to the wider data path. The octets of the full 256-bit key are labeled in order A, B, C, D, E, F, G, H, I, J, K, L, M, N, O, P, Q, R, S, T, U, V, W, X, Y, Z, AA, BB, CC, DD, EE and FF, with Q through FF replacing XA through XP in the AES description. About half of the Rijndael output multiplexers carry input labels single and double. Single corresponds to the case where a single key expansion is performed in a round and double is the case where two expansions are needed in a round, as seen in FIG.'s 31, 32, 36, 37 and 38. There can also be, e.g., a total of eight S-Boxes used in one round, with the 4 additional units, e.g., being used for either the second expansion of short keys or for the right half of a 256-bit key.

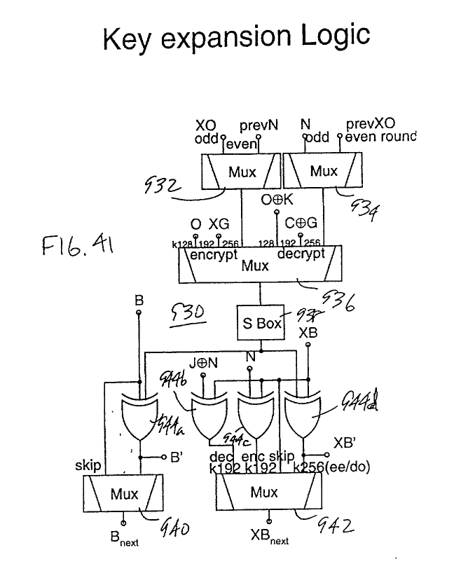

Turning now to FIG. 40 there is shown a portion of the key expansion logic for an implementation of an AES encryption/decryption integrated circuit. This portion 910 of the circuit has outputs rconₙₑₓₜ, Aₙₑₓₜ and XAₙₑₓₜ, respectively from, e.g., the multiplexers 920, 926, and 928. The inputs to the multiplexer 920 are, e.g., on the skip line the current rcon, e.g., in the first round the binary octet 00000001, on the enc line the current round rcon multiplied by 2 in X2 box 922, and on the dec line the current round rcon divided by 2 in the /2 box 924. The inputs to the multiplexer 926 may be, e.g., on the skip line the current round A and on the /skip (don't skip) line the output of an Xor gate 921a having as inputs the current round A, the output from an S-Box 918 and rcon. The inputs of this exemplary circuit 910 to the multiplexer 928 can be, e.g., on the dec and k192 line the output of an Xor circuit 921b, the inputs to which are XA and I⊕M, and on the enc and k192 line the output of an Xor circuit 921c, the inputs to which are M and XA, on the skip line XA and on the k256(ee/do) line XA′, the output of an Xor circuit 921d, the inputs to which are XA and the output of the S-Box 918. The input to the S-Box 918, may be, e.g., the output of a multiplexer 916, the inputs to which may be, e.g., in the encryption mode and on the k128 line N, on the k192 line XF and on the k256 line the output of a multiplexer 912, and in the decryption mode on the k128 line J⊕N, on the k192 line B⊕F and on the k256 line the output of a multiplexer 914. The input to the multiplexer 912, may be, e.g., on the odd line XN and on the even line the previous round input M. The inputs to the multiplexer 914 can be, e.g., on the odd line M and on the even line the previous round input XN.

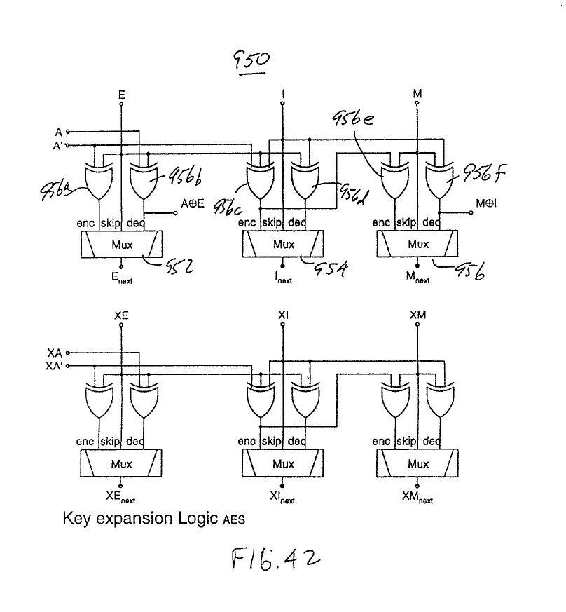

Turning now to FIG. 41, there is shown an exemplary embodiment of another portion 930 of the key expansion circuitry for encryption and decryption. The circuit 930 has as it outputs, e.g., Bₙₑₓₜ and XBₙₑₓₜ. The inputs to the circuit 930 are XO on the odd line input to a multiplexer 932 and the previous round input N on the even line input to the multiplexer 932. In addition N forms an input on the odd line to a multiplexer 934 and the previous round input XO forms an input on the even line to the multiplexer 934. A multiplexer 936 has as its inputs, e.g., in the encryption mode on the k128 line O, on the k192 line XG and on the k256 line the output of the multiplexer 932, and in the decrypt mode, on the k128 line O⊕K, on the k192 line C⊕G, and on the k256 line the output of the multiplexer 934. The output of the multiplexer 936 can be the input to an S-Box 938. The output of the S-Box 938 can form an input to an Xor circuit 944a, the other input to which may be B, and the output of which Xor circuit 944a can be the input to a multiplexer 940 on the don't skip line, the output of which multiplexer 940 is Bₙₑₓₜ. Another input to the multiplexer 940 on the skip line is B. The output of the S-Box can also be the input to an Xor circuit 944d, another input of which can be XB, and the output of which XB″ can be the input to a multiplexer 942 on the 256(ee/do) line. Other inputs to the multiplexer 942, the output of which is XBₙₑₓₜ, can be on the k192 and dec line the output of an Xor circuit 944b, the inputs to which can be J⊕N and XB, and on the k192 and enc line the output of an Xor circuit 944c, the inputs to which can be N and XB and on the skip line XB. The circuit 930 can be duplicated several times in the exemplary embodiment of a key expansion logic circuit according to an implementation of the present invention, with Table 6 below listing the exemplary inputs/outputs for, e.g., the corresponding elements of circuit 930 for, e.g., the outputs Cₙₑₓₜ, XCₙₑₓₜ and Dₙₑₓₜ, XDₙₑₓₜ.

TABLE 6

| Element | In | Out | In | Out |
|---|---|---|---|---|
| 932 | odd XP | | odd XM | |
| | even prev O | | even prev P | |
| 934 | odd O | | odd P | |
| | even prev | | even prev | |
| | XP | | XM | |
| 936 | enc k128 P | | enc k128 M | |
| | enc k192 | | enc k192 | |
| | XH | | XE | |
| | dec k128 | | dec k128 | |
| | P⊕L | | I⊕M | |
| | dec k192 | | dec k192 | |
| | D⊕H | | A⊕E | |
| 944a | C | | D | |
| 944b | XC | | XD | |
| | K⊕O | | L⊕P | |
| 944c | XC | | XD | |
| | O | | P | |
| 944d | XC | | XD | |
| | S-Box out | | S-Box out | |
| 940 | | Cₙₑₓₜ | | Dₙₑₓₜ |
| 942 | | XCₙₑₓₜ | | XDₙₑₓₜ |

Turning now to FIG. 42 there is shown an example of an implementation of a further portion of the key expansion logic circuit according to the present invention for the outputs Eₙₑₓₜ, Iₙₑₓₜ and Mₙₑₓₜ. The value for Eₙₑₓₜ in circuit 950 may be formed, e.g., from the output of a multiplexer 952, the input to which on the enc line is the output of an Xor circuit 956a, the inputs to which are E and A′, on the skip line E, and on the dec line the output of an Xor circuit 956b, the inputs to which are A and E. The output Iₙₑₓₜ may be formed by the output of a multiplexer 954, the inputs to which may be, on the enc line the output of an Xor circuit 956c, the inputs to which are A′, I and E, on the skip line I and on the dec line the output of an Xor gate 956d, the inputs to which are E and I. The output Mₙₑₓₜ may be formed, e.g., from the output of a multiplexer 956, the inputs to which are on the enc line the output of an Xor circuit 956e, the inputs to which are M and the output of Xor circuit 956b, on the skip line M and on the dec line the output of an Xor circuit 956f, the inputs to which are M and I. The outputs XEₙₑₓₜ, XIₙₑₓₜ and XMₙₑₓₜ can be formed in essentially an identical circuit, with the inputs A and A′ replaced by XA and XA′ and the inputs E, I and M replaced with inputs XE, XI and XM. In like manner, the outputs Fₙₑₓₜ, Jₙₑₓₜ and Nₙₑₓₜ, XFₙₑₓₜ and XJₙₑₓₜ may be formed with, e.g., the identical circuit 950 with the inputs A, A′ and XA, XA′ replaced respectively by B, B′ and XB, XB′ and the inputs E, I and M replaced by, respectively F, J and N and XE, XF and XM replaced by XF, XJ and XN. The identical circuit to circuit 950 can also, e.g., produce, Gₙₑₓₜ, Kₙₑₓₜ and Oₙₑₓₜ along with XGₙₑₓₜ, XKₙₑₓₜ and XOₙₑₓₜ as explained with regard to FIG. 42 and the inputs C, C′ and XC, XC′ and G, K and O and XG, XK and XO. Finally the outputs Hₙₑₓₜ, Lₙₑₓₜ and Pₙₑₓₜ along with XHₙₑₓₜ, XLₙₑₓₜ and XPₙₑₓₜ can be produced, e.g., with the circuit 950 of FIG. 42 and the respective inputs D, D′ and XD, XD′ and H, L and P and XH, XL and XP.

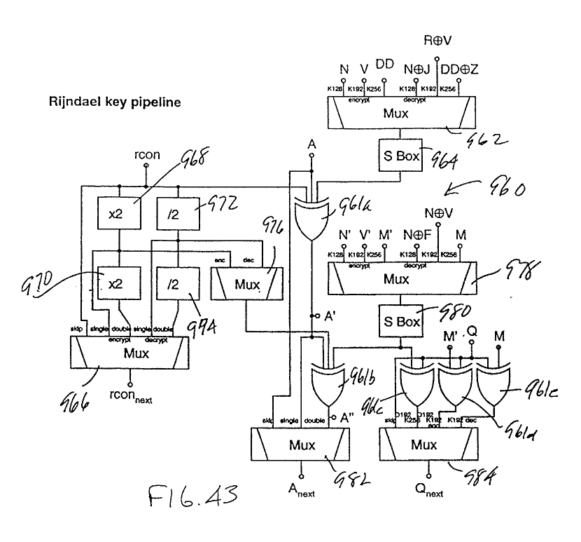

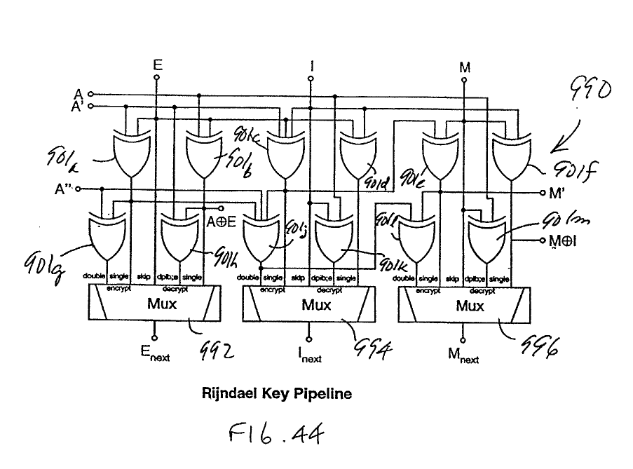

Turning now to FIG. 43 there is shown an example of an implementation of a portion of a key expansion logic circuit for a full Rijndael implementation, i.e., where the data block length may also be 128, 192 or 256. The circuit 960 of FIG. 43 may produce, e.g., the outputs Aₙₑₓₜ and Qₙₑₓₜ, along with rconₙₑₓₜ. Inputs to the circuit may include inputs to a multiplexer 962 in the encryption mode on the k128 line N, on the K192 line V and on the K256 line DD (corresponding to XN), and in the decryption mode on the k128 line N⊕J, on the k192 line R⊕V and on the k256 line DD⊕Z (corresponding to XJ). The output of the multiplexer 962 can provide the input to an S-Box 964, which may be the same as the S-Box 918 in FIG. 40. The inputs N′, V′, M′, N⊕F, N⊕V and M may form the equivalent inputs, respectively, to a multiplexer 978 as the N, V, DD, N⊕J, R⊕V and DD⊕Z inputs to the multiplexer 962. The output of the multiplexer 978 may form the input to an S-box 980 like S-Box 964.

The circuit 960, also can include an rconₙₑₓₜ generation circuit. The output rconₙₑₓₜ can be the output of a multiplexer 966, the inputs to which can be on the skip line rcon, in the encryption mode on the single line the value of rcon multiplied by 2 in box 968 and on the double line the output of box 968 multiplied by 2 in box 970, and in the decryption mode on the single line, the value of rcon divided by 2 in box 972 and on the double line the output of box 972 divided by 2 in box 974. The output Anew can be, the output of, e.g., a multiplexer 982, the inputs to which are on the skip line A, on the single line, the output of an Xor circuit 961a, the inputs to which can be rcon, A and the output of s-Box 964, and on the double line the output A″ from an Xor circuit 961b, the inputs to which can be, e.g., the output of a multiplexer 976, the inputs to which are on the enc line the value rcon multiplied by 2 in box 968 and on the dec line the value of rcon divided by 2 in box 972. Additional inputs to the Xor circuit 961b can be the output A′ from the Xor circuit 961a and the output of the S-Box 980.

The output Qₙₑₓₜ can be the output of, e.g., a multiplexer 984, the inputs to which can be on the skip line Q, on the D192/K256 line the output Q″ of an Xor circuit 961c, the inputs to which can be Q and the output of S-Box 980, and on the D192/K256/enc line the output of an Xor circuit 961d, the inputs to which can be M′ and Q, and on the K192/dec line the output of an Xor circuit 961e, the inputs to which can be Q and M. The circuit 960 can be repeated several times, absent the rcon portion of the circuit, with Table 7 showing the variable inputs and outputs of the circuit elements.

TABLE 7

| Elements | In | Out | In | Out | In | Out |
|---|---|---|---|---|---|---|
| 962 | | | | | | |
| enc/K128 | O | | P | | M | |
| enc/K192 | W | | X | | U | |
| enc/K256 | EE | | FF | | CC | |
| dec/K128 | O⊕K | | P⊕L | | M⊕I | |
| dec/K192 | S⊕W | | T⊕X | | Q⊕U | |
| dec/K256 | EE⊕AA | | FF⊕BB | | CC⊕Y | |
| 978 | | | | | | |
| enc/K128 | O′ | | P′ | | M′ | |
| enc/K192 | W′ | | X′ | | U′ | |
| enc/K256 | N′ | | O′ | | P′ | |
| dec/K128 | O⊕G | | P⊕H | | M⊕E | |
| dec/K192 | O⊕W | | P⊕X | | M⊕U | |
| dec/K256 | N | | O | | P | |
| 961a | B | | C | | D | |
| 961c | R | | S | | T | |
| 961d | N′, R | | O′, S | | P′, T | |
| 961e | N, R | | O, S | | P, T | |
| 961e | N | | O | | P | |
| 982 | | Bₙₑₓₜ | | Cₙₑₓₜ | | Dₙₑₓₜ |
| 984 | | Rₙₑₓₜ | | Sₙₑₓₜ | | Tₙₑₓₜ |

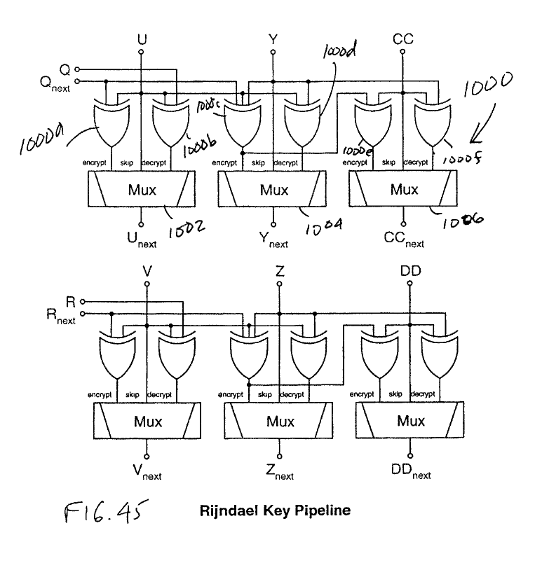

Turning now to FIG. 44, there in shown a possible implementation of another portion of a full Rijndael key expansion pipeline 990. The circuit 990 may have a plurality of Xor circuits, 901a-901m. The circuit may also have a plurality of multiplexers 992, 994 and 996. The output of the multiplexer 992 may be, e.g., Eₙₑₓₜ, with the inputs to the multiplexer 992 being, e.g., on the skip line E, on the enc/double line the output of the Xor circuit 901g, the inputs to which are A″ and the output of the Xor circuit 901a, the inputs to which are A′ and E, and on the enc/single line, the output of the Xor circuit 901a, and on the dec/double line the output of an Xor circuit 901h, the inputs to which may be A′ and the output of an Xor circuit 901b, the inputs to which may be A and E, and on the dec/single line the output of the Xor circuit 901b. The output of the multiplexer 994 may be, e.g., IneXt, with the inputs to the multiplexer 994 being, e.g., on the enc/double line the output of an Xor circuit 901j, the inputs to which can be A″, the output of the Xor circuit 901a and the output of an Xor circuit 901c, the inputs to which may be A′, E and I, and on the enc/single line the output of the Xor circuit 901c, and on the skip line I, and on the dec/double line the output of an Xor circuit 901k, the inputs to which may be A and I, and on the dec/single line the output of an Xor circuit 901d, the inputs to which may be I and E. The output of the multiplexer 996 may be, e.g., Mₙₑₓₜ, with the inputs to the multiplexer 996 being, e.g., on the enc/double line, the output of an Xor circuit 9011, the inputs to which may be, e.g., the output of the Xor circuit 901j and M′, and on the enc/single line the output of an Xor circuit 901e, the inputs to which may be the output of the Xor circuit 901c and M, and on the skip line M, and on the dec/double line the output of an Xor circuit, the inputs to which may be, e.g., M and A, and on the dec/single line the output of an Xor circuit 901f, the inputs to which may be M and I. This circuit 990 may be repeated several times, with the outputs from left to right as shown in FIG. 44 being, e.g., Fₙₑₓₜ, Jₙₑₓₜ and Nₙₑₓₜ, with the corresponding inputs from left to right as shown in FIG. 44 being F, J and N, and with the corresponding left vertical inputs, from to bottom as shown in FIG. 44 being B, B′ and B″ and the right input as shown in FIG. 44 being, N′. Similarly the same circuit can be implemented, e.g., for the outputs from left to right of Gₙₑₓₜ, Kₙₑₓₜ and Oₙₑₓₜ with inputs G, K and O, along with inputs C, C′ and C″ and O′, and for the outputs, e.g., Hₙₑₓₜ, Lₙₑₓₜ and Pₙₑₓₜ, with the inputs H, L and P, along with D, D′ and D″ and P′ corresponding to the inputs and outputs shown in FIG. 44.

Turning now to FIG. 45, there is shown a possible implementation of a further portion 1000 of a full Rijndael key expansion circuit. The circuit 1000 may include a plurality of Xor circuits 1000a-1000f and a plurality of multiplexers 1002, 1004 and 1006. The output of the multiplexer 1002 may be, e.g., Uₙₑₓₜ with the inputs to the multiplexer 1002 being, e.g., on the enc line the output of the Xor circuit 1000a, the inputs to which may be Qₙₑₓₜ and U, and on the skip line U and on the dec line the output of the Xor circuit 1000b, the inputs to which may be U and Q. The output of the multiplexer 1004 may be, e.g., Yₙₑₓₜ with the inputs to the multiplexer 1004 being, e.g., on the enc line the output of the Xor circuit 1000c, the inputs to which may be, e.g., U, Qₙₑₓₜ and Y, and on the skip line Y, and on the dec line the output of the Xor circuit 1000d, the inputs to which may be, e.g., U and Y. The output of the multiplexer 10006 may be, e.g., CCₙₑₓₜ, with the input to the multiplexer 1006 being, e.g., on the enc line the output of the Xor circuit 1000e, the inputs to which may be, e.g., the output of the Xor circuit 1000c and CC, and on the skip line CC and on the dec line the output of the Xor circuit 1000f, the inputs to which may be, e.g., Y and CC. This circuit 1000 may also be repeated for the outputs, e.g., Vₙₑₓₜ, Zₙₑₓₜ and DDₙₑₓₜ with the corresponding inputs as shown in FIG. 45 being V, Z and DD and R and Rₙₑₓₜ, for Wₙₑₓₜ, AAₙₑₓₜ and EEₙₑₓₜ, with the corresponding inputs or W, AA and EE and S and Sₙₑₓₜ, and for Xₙₑₓₜ, BBₙₑₓₜ and FFₙₑₓₜ, with the corresponding inputs of X, B and FF, along with T and Tₙₑₓₜ.

A rough estimate of the gate count for a linear pipeline fully unrolling the 14 rounds maximum and supporting both encryption and decryption in all three block lengths in one pipeline has a complexity on the order of 2 million gates. With pipeline staging at each round boundary, a 500 MHz clock should be readily achievable, providing a pipeline throughput over 100 Gbps. For the proposed AES standard 128-bit block width only, the basic pipeline is on the order of 1 million gates and 50 Gbps throughput. The throughput of a single pipeline is high enough that the real limiting factor is likely to be input/output bandwidth to the outside. The minimum practical encryption core would implement a 32-bit wide data path and a single round in hardware, in perhaps 30 to 40 thousand gates, and would take about 50 clock cycles per block. Such a minimal implementation would be useful in ASIC libraries as a way to provide encryption support at throughputs comparable to software implementations on high-end microprocessors without the resources of adding a Pentium-III class chip. In all of these complexity estimates, the substitution tables are the dominant factor.

The foregoing invention has been described in relation to a presently preferred embodiment thereof. The invention should not be considered limited to this embodiment. Those skilled in the art will appreciate that many variations and modifications to the presently preferred embodiment, many of which are specifically referenced above, may be made without departing from the spirit and scope of the appended claims. The inventions should be measured in scope from the appended claims.

I claim:

1. An encryption/decryption circuit comprising:
a staged pipelined logic circuit adapted to perform in series stages of encryption/decryption operations on a stage data block of a first selected width utilizing an encryption/decryption key of the first selected width and to provide an output data block of the first selected width, comprising a subsequent stage input data block input to a subsequent stage of the staged pipelined logic circuit;
a stage input data block buffer adapted to hold the stage input data block for input into a stage of the staged pipelined logic circuit, the input data block having the first selected width;
an encryption circuit adapted to encrypt the stage input data block into a encrypted stage input data block having the first selected width, the encrypted stage input data block comprising a unique combination of data bits for each unique combination of data bits in the stage input data block of the first selected width, and the encrypted stage input data block forming an input to a stage substitution circuit, the output of the stage substitution circuit forming a first subsequent stage input data block for a subsequent stage of the staged pipelined logic circuit;
a decryption circuit adapted to decrypt the stage input data block into a decrypted stage input data block having the first selected width, the decrypted stage input data block comprising a unique combination of data bits for each unique combination of data bits in the stage input data block of the first selected width that is the inverse of the encryption performed by the encryption circuit, the decrypted stage input data block forming a second subsequent stage input to the substitution circuit; and,
a first selector circuit adapted to select as the input to the substitution circuit the first or the second input.

2. The apparatus of claim 1, further comprising:
a second selector circuit adapted to select as the subsequent stage input data block for the subsequent stage of the staged pipelined logic circuit the output of the substitution circuit or the stage input data block.

3. The apparatus of claim 1 further comprising:
the staged pipelined logic circuit being further adapted to perform in series the stages of the encryption/decryption operations in a first plurality of stages of the staged pipelined logic circuit, each of the stages of the first plurality of stages comprising a round, and to repeat this operation for a selected number of times and for a selected number of rounds each of the selected number of times, to thereby effect a total number of rounds.

4. The apparatus of claim 2 further comprising:
the staged pipelined logic circuit being further adapted to perform in series the stages of the encryption/decryption operations in a first plurality of stages of the staged pipelined logic circuit, each of the stages of the first plurality of stages comprising a round, and to repeat this operation for a selected number of times and for a selected number of rounds each of the selected number of times, to thereby effect a total number of rounds.

5. The apparatus of claim 3 further comprising:
the staged pipelined logic circuit being further adapted to perform in any given one of the first plurality of times less than the first plurality of rounds depending upon the total number of rounds necessary.

6. The apparatus of claim 4 further comprising:
the staged pipelined logic circuit being further adapted to perform in any given one of the first plurality of times less than the first plurality of rounds depending upon the total number of rounds necessary.

7. The apparatus of claim 1 further comprising:
a round key generation circuit adapted to provide a round encryption or decryption key of the first selected width for combination with the block data of the first selected width, based upon an initial encryption or decryption key of a second selected width.

8. The apparatus of claim 2 further comprising:
a round key generation circuit adapted to provide a round encryption or decryption key of the first selected width for combination with the block data of the first selected width, based upon an initial encryption or decryption key of a second selected width.

9. The apparatus of claim 3 further comprising:
a round key generation circuit adapted to provide a round encryption or decryption key of the first selected width for combination with the block data of the first selected width, based upon an initial encryption or decryption key of a second selected width.

10. The apparatus of claim 4 further comprising:
a round key generation circuit adapted to provide a round encryption or decryption key of the first selected width for combination with the block data of the first selected width, based upon an initial encryption or decryption key of a second selected width.

11. The apparatus of claim 5 further comprising:
a round key generation circuit adapted to provide a round encryption or decryption key of the first selected width for combination with the block data of the first selected width, based upon an initial encryption or decryption key of a second selected width.

12. The apparatus of claim 6 further comprising:
a round key generation circuit adapted to provide a round encryption or decryption key of the first selected width for combination with the block data of the first selected width, based upon an initial encryption or decryption key of a second selected width.

13. The apparatus of claim 7, further comprising:
the round key generation circuit being adapted to generate each round key by the expansion of a starting key of a second selected width.

14. The apparatus of claim 8, further comprising:
the round key generation circuit being adapted to generate each round key by the expansion of a starting key of a second selected width.

15. The apparatus of claim 9, further comprising:
the round key generation circuit being adapted to generate each round key by the expansion of a starting key of a second selected width.

16. The apparatus of claim 10, further comprising:
the round key generation circuit being adapted to generate each round key by the expansion of a starting key of a second selected width.

17. The apparatus of claim 11, further comprising:
the round key generation circuit being adapted to generate each round key by the expansion of a starting key of a second selected width.

18. The apparatus of claim 12, further comprising:
the round key generation circuit being adapted to generate each round key by the expansion of a starting key of a second selected width.

19. The apparatus of claim 13, further comprising:
the second selected width equals the first selected width.

20. The apparatus of claim 14, further comprising:
the second selected width equals the first selected width.

21. The apparatus of claim 15, further comprising:
the second selected width equals the first selected width.

22. The apparatus of claim 16, further comprising:
the second selected width equals the first selected width.

23. The apparatus of claim 17, further comprising:
the second selected width equals the first selected width.

24. The apparatus of claim 18, further comprising:
the second selected width equals the first selected width.

25. The apparatus of claim 19 further comprising:
the encryption circuit is adapted to perform an affine transformation and the decryption circuit is adapted to perform an inverse of the affine transformation.

26. The apparatus of claim 20 further comprising:
the encryption circuit is adapted to perform an affine transformation and the decryption circuit is adapted to perform an inverse of the amine transformation.

27. The apparatus of claim 21 further comprising:
the encryption circuit is adapted to perform an affine transformation and the decryption circuit is adapted to perform an inverse of the affine transformation.

28. The apparatus of claim 22 further comprising:
the encryption circuit is adapted to perform an affine transformation and the decryption circuit is adapted to perform an inverse of the amine transformation.

29. The apparatus of claim 23 further comprising:
the encryption circuit is adapted to perform an affine transformation and the decryption circuit is adapted to perform an inverse of the affine transformation.

30. The apparatus of claim 24 further comprising:
the encryption circuit is adapted to perform an affine transformation and the decryption circuit is adapted to perform an inverse of the affine transformation.

31. An encryption/decryption circuit comprising:
a staged pipelined logic circuit adapted to perform in series stages of encryption/decryption operations on a stage data block of a first selected width utilizing an encryption/decryption key of the first selected width and to provide an output data block of the first selected width, comprising a subsequent stage input data block input to a subsequent stage of the staged pipelined logic circuit;
a stage input data block buffer adapted to hold the stage input data block for input into a stage of the staged pipelined logic circuit, the input data block having the first selected width;
an encryption circuit adapted to encrypt the stage input data block into a encrypted stage input data block having the first selected width, the encrypted stage input data block comprising a unique combination of data bits for each unique combination of data bits in the stage input data block of the first selected width, and the encrypted stage input data block forming an input to a stage substitution circuit, the output of the stage substitution circuit forming a first subsequent stage input data block for a subsequent stage of the staged pipelined logic circuit;
a decryption circuit adapted to decrypt the stage input data block into a decrypted stage input data block having the first selected width, the decrypted stage input data block comprising a unique combination of data bits for each unique combination of data bits in the stage input data block of the first selected width that is the inverse of the encryption performed by the encryption circuit, the decrypted stage input data block forming a second subsequent stage input to the substitution circuit;
a first selector circuit adapted to select as the input to the substitution circuit the first or the second input; and,
a second selector circuit adapted to select as the subsequent stage input data block for the subsequent stage of the staged pipelined logic circuit the output of the substitution circuit or the stage input data block.

32. An encryption/decryption circuit comprising:
a staged pipelined logic circuit adapted to perform in series stages of encryption/decryption operations on a stage data block of a first selected width utilizing an encryption/decryption key of the first selected width and to provide an output data block of the first selected width, comprising a subsequent stage input data block input to a subsequent stage of the staged pipelined logic circuit;
a stage input data block buffer adapted to hold the stage input data block for input into a stage of the staged pipelined logic circuit, the input data block having the first selected width;
an encryption circuit adapted to encrypt the stage input data block into a encrypted stage input data block having the first selected width, the encrypted stage input data block comprising a unique combination of data bits for each unique combination of data bits in the stage input data block of the first selected width, and the encrypted stage input data block forming an input to a stage substitution circuit, the output of the stage substitution circuit forming a first subsequent stage input data block for a subsequent stage of the staged pipelined logic circuit;
a decryption circuit adapted to decrypt the stage input data block into a decrypted stage input data block having the first selected width, the decrypted stage input data block comprising a unique combination of data bits for each unique combination of data bits in the stage input data block of the first selected width that is the inverse of the encryption performed by the encryption circuit, the decrypted stage input data block forming a second subsequent stage input to the substitution circuit;
a first selector circuit adapted to select as the input to the substitution circuit the first or the second input;
a second selector circuit adapted to select as the subsequent stage input data block for the subsequent stage of the staged pipelined logic circuit the output of the substitution circuit or the stage input data block; and,
the staged pipelined logic circuit being further adapted to perform in series the stages of the encryption/decryption operations in a first plurality of stages of the staged pipelined logic circuit, each of the stages of the first plurality of stages comprising a round, and to repeat this operation for a selected number of times and for a selected number of rounds each of the selected number of times, to thereby effect a total number of rounds.

33. An encryption/decryption circuit comprising:
a staged pipelined logic circuit adapted to perform in series stages of encryption/decryption operations on a stage data block of a first selected width utilizing an encryption/decryption key of the first selected width and to provide an output data block of the first selected width, comprising a subsequent stage input data block input to a subsequent stage of the staged pipelined logic circuit;
a stage input data block buffer adapted to hold the stage input data block for input into a stage of the staged pipelined logic circuit, the input data block having the first selected width;
an encryption circuit adapted to encrypt the stage input data block into a encrypted stage input data block having the first selected width, the encrypted stage input data block comprising a unique combination of data bits for each unique combination of data bits in the stage input data block of the first selected width, and the encrypted stage input data block forming an input to a stage substitution circuit, the output of the stage substitution circuit forming a first subsequent stage input data block for a subsequent stage of the staged pipelined logic circuit;
a decryption circuit adapted to decrypt the stage input data block into a decrypted stage input data block having the first selected width, the decrypted stage input data block comprising a unique combination of data bits for each unique combination of data bits in the stage input data block of the first selected width that is the inverse of the encryption performed by the encryption circuit, the decrypted stage input data block forming a second subsequent stage input to the substitution circuit;
a first selector circuit adapted to select as the input to the substitution circuit the first or the second input;
a second selector circuit adapted to select as the subsequent stage input data block for the subsequent stage of the staged pipelined logic circuit the output of the substitution circuit or the stage input data block;
the staged pipelined logic circuit being further adapted to perform in series the stages of the encryption/decryption operations in a first plurality of stages of the staged pipelined logic circuit, each of the stages of the first plurality of stages comprising a round, and to repeat this operation for a selected number of times and for a selected number of rounds each of the selected number of times, to thereby effect a total number of rounds; and,
the staged pipelined logic circuit being further adapted to perform in any given one of the first plurality of times less than the first plurality of rounds depending upon the total number of rounds necessary.

34. An encryption/decryption circuit comprising:
a staged pipelined logic circuit adapted to perform in series stages of encryption/decryption operations on a stage data block of a first selected width utilizing an encryption/decryption key of the first selected width and to provide an output data block of the first selected width, comprising a subsequent stage input data block input to a subsequent stage of the staged pipelined logic circuit;
a stage input data block buffer adapted to hold the stage input data block for input into a stage of the staged pipelined logic circuit, the input data block having the first selected width;
an encryption circuit adapted to encrypt the stage input data block into a encrypted stage input data block having the first selected width, the encrypted stage input data block comprising a unique combination of data bits for each unique combination of data bits in the stage input data block of the first selected width, and the encrypted stage input data block forming an input to a stage substitution circuit, the output of the stage substitution circuit forming a first subsequent stage input data block for a subsequent stage of the staged pipelined logic circuit;
a decryption circuit adapted to decrypt the stage input data block into a decrypted stage input data block having the first selected width, the decrypted stage input data block comprising a unique combination of data bits for each unique combination of data bits in the stage input data block of the first selected width that is the inverse of the encryption performed by the encryption circuit, the decrypted stage input data block forming a second subsequent stage input to the substitution circuit;
a first selector circuit adapted to select as the input to the substitution circuit the first or the second input;
a second selector circuit adapted to select as the subsequent stage input data block for the subsequent stage of the staged pipelined logic circuit the output of the substitution circuit or the stage input data block;
the staged pipelined logic circuit being further adapted to perform in series the stages of the encryption/decryption operations in a first plurality of stages of the staged pipelined logic circuit, each of the stages of the first plurality of stages comprising a round, and to repeat this operation for a selected number of times and for a selected number of rounds each of the selected number of times, to thereby effect a total number of rounds;
the staged pipelined logic circuit being further adapted to perform in any given one of the first plurality of times less than the first plurality of rounds depending upon the total number of rounds necessary; and,
a round key generation circuit adapted to provide a round encryption or decryption key of the first selected width for combination with the block data of the first selected width, based upon an initial encryption or decryption key of a second selected width.

35. An encryption/decryption circuit comprising:
a staged pipelined logic circuit adapted to perform in series stages of encryption/decryption operations on a stage data block of a first selected width utilizing an encryption/decryption key of the first selected width and to provide an output data block of the first selected width, comprising a subsequent stage input data block input to a subsequent stage of the staged pipelined logic circuit;
a stage input data block buffer adapted to hold the stage input data block for input into a stage of the staged pipelined logic circuit, the input data block having the first selected width;
an encryption circuit adapted to encrypt the stage input data block into a encrypted stage input data block having the first selected width, the encrypted stage input data block comprising a unique combination of data bits for each unique combination of data bits in the stage input data block of the first selected width, and the encrypted stage input data block forming an input to a stage substitution circuit, the output of the stage substitution circuit forming a first subsequent stage input data block for a subsequent stage of the staged pipelined logic circuit;
a decryption circuit adapted to decrypt the stage input data block into a decrypted stage input data block having the first selected width, the decrypted stage input data block comprising a unique combination of data bits for each unique combination of data bits in the stage input data block of the first selected width that is the inverse of the encryption performed by the encryption circuit, the decrypted stage input data block forming a second subsequent stage input to the substitution circuit;
a first selector circuit adapted to select as the input to the substitution circuit the first or the second input;
a second selector circuit adapted to select as the subsequent stage input data block for the subsequent stage of the staged pipelined logic circuit the output of the substitution circuit or the stage input data block;
the staged pipelined logic circuit being further adapted to perform in series the stages of the encryption/decryption operations in a first plurality of stages of the staged pipelined logic circuit, each of the stages of the first plurality of stages comprising a round, and to repeat this operation for a selected number of times and for a selected number of rounds each of the selected number of times, to thereby effect a total number of rounds;
the staged pipelined logic circuit being further adapted to perform in any given one of the first plurality of times less than the first plurality of rounds depending upon the total number of rounds necessary;
a round key generation circuit adapted to provide a round encryption or decryption key of the first selected width for combination with the block data of the first selected width, based upon an initial encryption or decryption key of a second selected width; and,
the round key generation circuit being adapted to generate each round key by the expansion of a starting key of a second selected width.

36. An encryption/decryption circuit comprising:
a staged pipelined logic circuit adapted to perform in series stages of encryption/decryption operations on a stage data block of a first selected width utilizing an encryption/decryption key of the first selected width and to provide an output data block of the first selected width, comprising a subsequent stage input data block input to a subsequent stage of the staged pipelined logic circuit;
a stage input data block buffer adapted to hold the stage input data block for input into a stage of the staged pipelined logic circuit, the input data block having the first selected width;
an encryption circuit adapted to encrypt the stage input data block into a encrypted stage input data block having the first selected width, the encrypted stage input data block comprising a unique combination of data bits for each unique combination of data bits in the stage input data block of the first selected width, and the encrypted stage input data block forming an input to a stage substitution circuit, the output of the stage substitution circuit forming a first subsequent stage input data block for a subsequent stage of the staged pipelined logic circuit;
a decryption circuit adapted to decrypt the stage input data block into a decrypted stage input data block having the first selected width, the decrypted stage input data block comprising a unique combination of data bits for each unique combination of data bits in the stage input data block of the first selected width that is the inverse of the encryption performed by the encryption circuit, the decrypted stage input data block forming a second subsequent stage input to the substitution circuit;
a first selector circuit adapted to select as the input to the substitution circuit the first or the second input;
a second selector circuit adapted to select as the subsequent stage input data block for the subsequent stage of the staged pipelined logic circuit the output of the substitution circuit or the stage input data block;
the staged pipelined logic circuit being further adapted to perform in series the stages of the encryption/decryption operations in a first plurality of stages of the staged pipelined logic circuit, each of the stages of the first plurality of stages comprising a round, and to repeat this operation for a selected number of times and for a selected number of rounds each of the selected number of times, to thereby effect a total number of rounds;
the staged pipelined logic circuit being further adapted to perform in any given one of the first plurality of times less than the first plurality of rounds depending upon the total number of rounds necessary;
a round key generation circuit adapted to provide a round encryption or decryption key of the first selected width for combination with the block data of the first selected width, based upon an initial encryption or decryption key of a second selected width; and,
the round key generation circuit being adapted to generate each round key by the expansion of a starting key of a second selected width, equal to the first selected width.

37. An encryption/decryption circuit comprising:
a staged pipelined logic circuit adapted to perform in series stages of encryption/decryption operations on a stage data block of a first selected width utilizing an encryption/decryption key of the first selected width and to provide an output data block of the first selected width, comprising a subsequent stage input data block input to a subsequent stage of the staged pipelined logic circuit;
a stage input data block buffer adapted to hold the stage input data block for input into a stage of the staged pipelined logic circuit, the input data block having the first selected width;
an encryption circuit adapted to encrypt the stage input data block into a encrypted stage input data block having the first selected width, the encrypted stage input data block comprising a unique combination of data bits for each unique combination of data bits in the stage input data block of the first selected width, and the encrypted stage input data block forming an input to a stage substitution circuit, the output of the stage substitution circuit forming a first subsequent stage input data block for a subsequent stage of the staged pipelined logic circuit;
a decryption circuit adapted to decrypt the stage input data block into a decrypted stage input data block having the first selected width, the decrypted stage input data block comprising a unique combination of data bits for each unique combination of data bits in the stage input data block of the first selected width that is the inverse of the encryption performed by the encryption circuit, the decrypted stage input data block forming a second subsequent stage input to the substitution circuit;
a first selector circuit adapted to select as the input to the substitution circuit the first or the second input;
a second selector circuit adapted to select as the subsequent stage input data block for the subsequent stage of the staged pipelined logic circuit the output of the substitution circuit or the stage input data block;
the staged pipelined logic circuit being further adapted to perform in series the stages of the encryption/decryption operations in a first plurality of stages of the staged pipelined logic circuit, each of the stages of the first plurality of stages comprising a round, and to repeat this operation for a selected number of times and for a selected number of rounds each of the selected number of times, to thereby effect a total number of rounds;
the staged pipelined logic circuit being further adapted to perform in any given one of the first plurality of times less than the first plurality of rounds depending upon the total number of rounds necessary;
a round key generation circuit adapted to provide a round encryption or decryption key of the first selected width for combination with the block data of the first selected width, based upon an initial encryption or decryption key of a second selected width;
the round key generation circuit being adapted to generate each round key by the expansion of a starting key of a second selected width, equal to the first selected width; and,
the encryption circuit is adapted to perform an affine transformation and the decryption circuit is adapted to perform an inverse of the affine transformation.

38. An encryption/decryption circuit comprising:
a staged pipelined logic circuit means for performing in series stages of encryption/decryption operations on a stage data block of a first selected width utilizing an encryption/decryption key of the first selected width and providing an output data block of the first selected width, comprising a subsequent stage input data block input to a subsequent stage of the staged pipelined logic circuit;
a stage input data block buffer means for holding the stage input data block for input into a stage of the staged pipelined logic circuit, the input data block having the first selected width;
an encryption circuit means for encrypting the stage input data block into a encrypted stage input data block having the first selected width, the encrypted stage input data block comprising a unique combination of data bits for each unique combination of data bits in the stage input data block of the first selected width, and the encrypted stage input data block forming an input to a stage substitution circuit, the output of the stage substitution circuit forming a first subsequent stage input data block for a subsequent stage of the staged pipelined logic circuit means;
a decryption circuit means for decrypting the stage input data block into a decrypted stage input data block having the first selected width, the decrypted stage input data block comprising a unique combination of data bits for each unique combination of data bits in the stage input data block of the first selected width that is the inverse of the encryption performed by the encryption circuit, the decrypted stage input data block forming a second subsequent stage input to the substitution circuit; and,
a first selector circuit means for selecting as the input to the substitution circuit the first or the second input.

39. The apparatus of claim 38, further comprising:
a second selector circuit means for selecting as the subsequent stage input data block for the subsequent stage of the staged pipelined logic circuit means the output of the substitution circuit or the stage input data block.

40. The apparatus of claim 38 further comprising:
the staged pipelined logic circuit means further including means for performing in series the stages of the encryption/decryption operations in a first plurality of stages of the staged pipelined logic circuit means, each of the stages of the first plurality of stages comprising a round, and for repeating this operation for a selected number of times and for a selected number of rounds each of the selected number of times, to thereby effect a total number of rounds.

41. The apparatus of claim 39 further comprising:
the staged pipelined logic circuit means further including means for performing in series the stages of the encryption/decryption operations in a first plurality of stages of the staged pipelined logic circuit means, each of the stages of the first plurality of stages comprising a round, and for repeating this operation for a selected number of times and for a selected number of rounds each of the selected number of times, to thereby effect a total number of rounds.

42. The apparatus of claim 40 further comprising:
the staged pipelined logic circuit means further comprising means for performing in any given one of the first plurality of times less than the first plurality of rounds depending upon the total number of rounds necessary.

43. The apparatus of claim 41 further comprising:
the staged pipelined logic circuit means further comprising means for performing in any given one of the first plurality of times less than the first plurality of rounds depending upon the total number of rounds necessary.

44. The apparatus of claim 38 further comprising:
a round key generation circuit means for providing a round encryption or decryption key of the first selected width for combination with the block data of the first selected width, based upon an initial encryption or decryption key of a second selected width.

45. The apparatus of claim 39 further comprising:
a round key generation circuit means for providing a round encryption or decryption key of the first selected width for combination with the block data of the first selected width, based upon an initial encryption or decryption key of a second selected width.

46. The apparatus of claim 40 further comprising:
a round key generation circuit means for providing a round encryption or decryption key of the first selected width for combination with the block data of the first selected width, based upon an initial encryption or decryption key of a second selected width.

47. The apparatus of claim 41 further comprising:
a round key generation circuit means for providing a round encryption or decryption key of the first selected width for combination with the block data of the first selected width, based upon an initial encryption or decryption key of a second selected width.

48. The apparatus of claim 42 further comprising:
a round key generation circuit means for providing a round encryption or decryption key of the first selected width for combination with the block data of the first selected width, based upon an initial encryption or decryption key of a second selected width.

49. The apparatus of claim 43 further comprising:
a round key generation circuit means for providing a round encryption or decryption key of the first selected width for combination with the block data of the first selected width, based upon an initial encryption or decryption key of a second selected width.

50. The apparatus of claim 44, further comprising:
the round key generation circuit means further including means for generating each round key by the expansion of a starting key of a second selected width.

51. The apparatus of claim 45, further comprising:
the round key generation circuit means further including means for generating each round key by the expansion of a starting key of a second selected width.

52. The apparatus of claim 46, further comprising:
the round key generation circuit means further including means for generating each round key by the expansion of a starting key of a second selected width.

53. The apparatus of claim 47, further comprising:
the round key generation circuit means further including means for generating each round key by the expansion of a starting key of a second selected width.

54. The apparatus of claim 48, further comprising:
the round key generation circuit means further including means for generating each round key by the expansion of a starting key of a second selected width.

55. The apparatus of claim 49, further comprising:
the round key generation circuit means further including means for generating each round key by the expansion of a starting key of a second selected width.

56. The apparatus of claim 50, further comprising:
the second selected width equals the first selected width.

57. The apparatus of claim 51, further comprising:
the second selected width equals the first selected width.

58. The apparatus of claim 52, further comprising:
the second selected width equals the first selected width.

59. The apparatus of claim 53, further comprising:
the second selected width equals the first selected width.

60. The apparatus of claim 54, further comprising:
the second selected width equals the first selected width.

61. The apparatus of claim 55, further comprising:
the second selected width equals the first selected width.

62. The apparatus of claim 56 further comprising:
the encryption circuit means further includes means for performing an affine transformation and the decryption circuit means further includes means for performing an inverse of the affine transformation.

63. The apparatus of claim 57 further comprising:
the encryption circuit means further includes means for performing an affine transformation and the decryption circuit means further includes means for performing an inverse of the affine transformation.

64. The apparatus of claim 58 further comprising:
the encryption circuit means further includes means for performing an affine transformation and the decryption circuit means further includes means for performing an inverse of the affine transformation.

65. The apparatus of claim 59 further comprising:
the encryption circuit means further includes means for performing an affine transformation and the decryption circuit means further includes means for performing an inverse of the affine transformation.

66. The apparatus of claim 60 further comprising:
the encryption circuit means further includes means for performing an affine transformation and the decryption circuit means further includes means for performing an inverse of the affine transformation.

67. The apparatus of claim 61 further comprising:
the encryption circuit means further includes means for performing an affine transformation and the decryption circuit means further includes means for performing an inverse of the affine transformation.

68. An encryption/decryption circuit comprising:
a staged pipelined logic circuit means for performing in series stages of encryption/decryption operations on a stage data block of a first selected width utilizing an encryption/decryption key of the first selected width and providing an output data block of the first selected width, comprising a subsequent stage input data block input to a subsequent stage of the staged pipelined logic circuit;
a stage input data block buffer means for holding the stage input data block for input into a stage of the staged pipelined logic circuit, the input data block having the first selected width;
an encryption circuit means for encrypting the stage input data block into a encrypted stage input data block having the first selected width, the encrypted stage input data block comprising a unique combination of data bits for each unique combination of data bits in the stage input data block of the first selected width, and the encrypted stage input data block forming an input to a stage substitution circuit, the output of the stage substitution circuit forming a first subsequent stage input data block for a subsequent stage of the staged pipelined logic circuit means;
a decryption circuit means for decrypting the stage input data block into a decrypted stage input data block having the first selected width, the decrypted stage input data block comprising a unique combination of data bits for each unique combination of data bits in the stage input data block of the first selected width that is the inverse of the encryption performed by the encryption circuit, the decrypted stage input data block forming a second subsequent stage input to the substitution circuit;
a first selector circuit means for selecting as the input to the substitution circuit the first or the second input; and,
a second selector circuit means for selecting as the subsequent stage input data block for the subsequent stage of the staged pipelined logic circuit means the output of the substitution circuit or the stage input data block.

69. An encryption/decryption circuit comprising:
a staged pipelined logic circuit means for performing in series stages of encryption/decryption operations on a stage data block of a first selected width utilizing an encryption/decryption key of the first selected width and providing an output data block of the first selected width, comprising a subsequent stage input data block input to a subsequent stage of the staged pipelined logic circuit;
a stage input data block buffer means for holding the stage input data block for input into a stage of the staged pipelined logic circuit, the input data block having the first selected width;
an encryption circuit means for encrypting the stage input data block into a encrypted stage input data block having the first selected width, the encrypted stage input data block comprising a unique combination of data bits for each unique combination of data bits in the stage input data block of the first selected width, and the encrypted stage input data block forming an input to a stage substitution circuit, the output of the stage substitution circuit forming a first subsequent stage input data block for a subsequent stage of the staged pipelined logic circuit means;
a decryption circuit means for decrypting the stage input data block into a decrypted stage input data block having the first selected width, the decrypted stage input data block comprising a unique combination of data bits for each unique combination of data bits in the stage input data block of the first selected width that is the inverse of the encryption performed by the encryption circuit, the decrypted stage input data block forming a second subsequent stage input to the substitution circuit;
a first selector circuit means for selecting as the input to the substitution circuit the first or the second input;
a second selector circuit means for selecting as the subsequent stage input data block for the subsequent stage of the staged pipelined logic circuit means the output of the substitution circuit or the stage input data block; and,
the staged pipelined logic circuit means further including means for performing in series the stages of the encryption/decryption operations in a first plurality of stages of the staged pipelined logic circuit means, each of the stages of the first plurality of stages comprising a round, and for repeating this operation for a selected number of times and for a selected number of rounds each of the selected number of times, to thereby effect a total number of rounds.

70. An encryption/decryption circuit comprising:
a staged pipelined logic circuit means for performing in series stages of encryption/decryption operations on a stage data block of a first selected width utilizing an encryption/decryption key of the first selected width and providing an output data block of the first selected width, comprising a subsequent stage input data block input to a subsequent stage of the staged pipelined logic circuit;
a stage input data block buffer means for holding the stage input data block for input into a stage of the staged pipelined logic circuit, the input data block having the first selected width;
an encryption circuit means for encrypting the stage input data block into a encrypted stage input data block having the first selected width, the encrypted stage input data block comprising a unique combination of data bits for each unique combination of data bits in the stage input data block of the first selected width, and the encrypted stage input data block forming an input to a stage substitution circuit, the output of the stage substitution circuit forming a first subsequent stage input data block for a subsequent stage of the staged pipelined logic circuit means;
a decryption circuit means for decrypting the stage input data block into a decrypted stage input data block having the first selected width, the decrypted stage input data block comprising a unique combination of data bits for each unique combination of data bits in the stage input data block of the first selected width that is the inverse of the encryption performed by the encryption circuit, the decrypted stage input data block forming a second subsequent stage input to the substitution circuit;
a first selector circuit means for selecting as the input to the substitution circuit the first or the second input;
a second selector circuit means for selecting as the subsequent stage input data block for the subsequent stage of the staged pipelined logic circuit means the output of the substitution circuit or the stage input data block;
the staged pipelined logic circuit means further including means for performing in series the stages of the encryption/decryption operations in a first plurality of stages of the staged pipelined logic circuit means, each of the stages of the first plurality of stages comprising a round, and for repeating this operation for a selected number of times and for a selected number of rounds each of the selected number of times, to thereby effect a total number of rounds; and,
the staged pipelined logic circuit means further comprising means for performing in any given one of the first plurality of times less than the first plurality of rounds depending upon the total number of rounds necessary.

71. An encryption/decryption circuit comprising:
a staged pipelined logic circuit means for performing in series stages of encryption/decryption operations on a stage data block of a first selected width utilizing an encryption/decryption key of the first selected width and providing an output data block of the first selected width, comprising a subsequent stage input data block input to a subsequent stage of the staged pipelined logic circuit,
a stage input data block buffer means for holding the stage input data block for input into a stage of the staged pipelined logic circuit, the input data block having the first selected width;
an encryption circuit means for encrypting the stage input data block into a encrypted stage input data block having the first selected width, the encrypted stage input data block comprising a unique combination of data bits for each unique combination of data bits in the stage input data block of the first selected width, and the encrypted stage input data block forming an input to a stage substitution circuit, the output of the stage substitution circuit forming a first subsequent stage input data block for a subsequent stage of the staged pipelined logic circuit means;
a decryption circuit means for decrypting the stage input data block into a decrypted stage input data block having the first selected width, the decrypted stage input data block comprising a unique combination of data bits for each unique combination of data bits in the stage input data block of the first selected width that is the inverse of the encryption performed by the encryption circuit, the decrypted stage input data block forming a second subsequent stage input to the substitution circuit;
a first selector circuit means for selecting as the input to the substitution circuit the first or the second input;
a second selector circuit means for selecting as the subsequent stage input data block for the subsequent stage of the staged pipelined logic circuit means the output of the substitution circuit or the stage input data block;
the staged pipelined logic circuit means further including means for performing in series the stages of the encryption/decryption operations in a first plurality of stages of the staged pipelined logic circuit means, each of the stages of the first plurality of stages comprising a round, and for repeating this operation for a selected number of times and for a selected number of rounds each of the selected number of times, to thereby effect a total number of rounds;
the staged pipelined logic circuit means further comprising means for performing in any given one of the first plurality of times less than the first plurality of rounds depending upon the total number of rounds necessary; and,
a round key generation circuit means for providing a round encryption or decryption key of the first selected width for combination with the block data of the first selected width, based upon an initial encryption or decryption key of a second selected width.

72. An encryption/decryption circuit comprising:
a staged pipelined logic circuit means for performing in series stages of encryption/decryption operations on a stage data block of a first selected width utilizing an encryption/decryption key of the first selected width and providing an output data block of the first selected width, comprising a subsequent stage input data block input to a subsequent stage of the staged pipelined logic circuit,
a stage input data block buffer means for holding the stage input data block for input into a stage of the staged pipelined logic circuit, the input data block having the first selected width;
an encryption circuit means for encrypting the stage input data block into a encrypted stage input data block having the first selected width, the encrypted stage input data block comprising a unique combination of data bits for each unique combination of data bits in the stage input data block of the first selected width, and the encrypted stage input data block forming an input to a stage substitution circuit, the output of the stage substitution circuit forming a first subsequent stage input data block for a subsequent stage of the staged pipelined logic circuit means;
a decryption circuit means for decrypting the stage input data block into a decrypted stage input data block having the first selected width, the decrypted stage input data block comprising a unique combination of data bits for each unique combination of data bits in the stage input data block of the first selected width that is the inverse of the encryption performed by the encryption circuit, the decrypted stage input data block forming a second subsequent stage input to the substitution circuit;
a first selector circuit means for selecting as the input to the substitution circuit the first or the second input;
a second selector circuit means for selecting as the subsequent stage input data block for the subsequent stage of the staged pipelined logic circuit means the output of the substitution circuit or the stage input data block;
the staged pipelined logic circuit means further including means for performing in series the stages of the encryption/decryption operations in a first plurality of stages of the staged pipelined logic circuit means, each of the stages of the first plurality of stages comprising a round, and for repeating this operation for a selected number of times and for a selected number of rounds each of the selected number of times, to thereby effect a total number of rounds;
the staged pipelined logic circuit means further comprising means for performing in any given one of the first plurality of times less than the first plurality of rounds depending upon the total number of rounds necessary;
a round key generation circuit means for providing a round encryption or decryption key of the first selected width for combination with the block data of the first selected width, based upon an initial encryption or decryption key of a second selected width; and,
the round key generation circuit means further including means for generating each round key by the expansion of a starting key of a second selected width.

73. An encryption/decryption circuit comprising:
a staged pipelined logic circuit means for performing in series stages of encryption/decryption operations on a stage data block of a first selected width utilizing an encryption/decryption key of the first selected width and providing an output data block of the first selected width, comprising a subsequent stage input data block input to a subsequent stage of the staged pipelined logic circuit;
a stage input data block buffer means for holding the stage input data block for input into a stage of the staged pipelined logic circuit, the input data block having the first selected width;
an encryption circuit means for encrypting the stage input data block into a encrypted stage input data block having the first selected width, the encrypted stage input data block comprising a unique combination of data bits for each unique combination of data bits in the stage input data block of the first selected width, and the encrypted stage input data block forming an input to a stage substitution circuit, the output of the stage substitution circuit forming a first subsequent stage input data block for a subsequent stage of the staged pipelined logic circuit means;
a decryption circuit means for decrypting the stage input data block into a decrypted stage input data block having the first selected width, the decrypted stage input data block comprising a unique combination of data bits for each unique combination of data bits in the stage input data block of the first selected width that is the inverse of the encryption performed by the encryption circuit, the decrypted stage input data block forming a second subsequent stage input to the substitution circuit;
a first selector circuit means for selecting as the input to the substitution circuit the first or the second input;
a second selector circuit means for selecting as the subsequent stage input data block for the subsequent stage of the staged pipelined logic circuit means the output of the substitution circuit or the stage input data block;
the staged pipelined logic circuit means further including means for performing in series the stages of the encryption/decryption operations in a first plurality of stages of the staged pipelined logic circuit means, each of the stages of the first plurality of stages comprising a round, and for repeating this operation for a selected number of times and for a selected number of rounds each of the selected number of times, to thereby effect a total number of rounds;
the staged pipelined logic circuit means further comprising means for performing in any given one of the first plurality of times less than the first plurality of rounds depending upon the total number of rounds necessary;
a round key generation circuit means for providing a round encryption or decryption key of the first selected width for combination with the block data of the first selected width, based upon an initial encryption or decryption key of a second selected width; and,
the round key generation circuit means further including means for generating each round key by the expansion of a starting key of a second selected width equal to the first selected width.

74. An encryption/decryption circuit comprising:
a staged pipelined logic circuit means for performing in series stages of encryption/decryption operations on a stage data block of a first selected width utilizing an encryption/decryption key of the first selected width and providing an output data block of the first selected width, comprising a subsequent stage input data block input to a subsequent stage of the staged pipelined logic circuit;
a stage input data block buffer means for holding the stage input data block for input into a stage of the staged pipelined logic circuit, the input data block having the first selected width;
an encryption circuit means for encrypting the stage input data block into a encrypted stage input data block having the first selected width, the encrypted stage input data block comprising a unique combination of data bits for each unique combination of data bits in the stage input data block of the first selected width, and the encrypted stage input data block forming an input to a stage substitution circuit, the output of the stage substitution circuit forming a first subsequent stage input data block for a subsequent stage of the staged pipelined logic circuit means;
a decryption circuit means for decrypting the stage input data block into a decrypted stage input data block having the first selected width, the decrypted stage input data block comprising a unique combination of data bits for each unique combination of data bits in the stage input data block of the first selected width that is the inverse of the encryption performed by the encryption circuit, the decrypted stage input data block forming a second subsequent stage input to the substitution circuit;
a first selector circuit means for selecting as the input to the substitution circuit the first or the second input;
a second selector circuit means for selecting as the subsequent stage input data block for the subsequent stage of the staged pipelined logic circuit means the output of the substitution circuit or the stage input data block;
the staged pipelined logic circuit means further including means for performing in series the stages of the encryption/decryption operations in a first plurality of stages of the staged pipelined logic circuit means, each of the stages of the first plurality of stages comprising a round, and for repeating this operation for a selected number of times and for a selected number of rounds each of the selected number of times, to thereby effect a total number of rounds;
the staged pipelined logic circuit means further comprising means for performing in any given one of the first plurality of times less than the first plurality of rounds depending upon the total number of rounds necessary;
a round key generation circuit means for providing a round encryption or decryption key of the first selected width for combination with the block data of the first selected width, based upon an initial encryption or decryption key of a second selected width;
the round key generation circuit means further including means for generating each round key by the expansion of a starting key of a second selected width equal to the first selected width; and,
the encryption circuit means further includes means for performing an affine transformation and the decryption circuit means further includes means for performing an inverse of the affine transformation.

75. An encryption/decryption method comprising:
performing in series stages of encryption/decryption operations on a stage data block of a first selected width utilizing an encryption/decryption key of the first selected width and providing an output data block of the first selected width, comprising a subsequent stage input data block input to a subsequent stage of the series of stages;
holding the stage input data block for input into a stage of the series of stages, the input data block having the first selected width;
encrypting the stage input data block into a encrypted stage input data block having the first selected width, the encrypted stage input data block comprising a unique combination of data bits for each unique combination of data bits in the stage input data block of the first selected width;
decrypting the stage input data block into a decrypted stage input data block having the first selected width, the decrypted stage input data block comprising a unique combination of data bits for each unique combination of data bits in the stage input data block of the first selected width that is the inverse of the encryption performed by the encryption step; and,
performing a substitution operation on either the encrypted stage input data block or the decrypted stage input data block.

76. The method of claim 75, further comprising:
selecting as a subsequent stage input data block for the subsequent stage of the series of stages the output of the substitution step or the stage input data block.

77. The method of claim 76 further comprising:
performing in series the stages of the encryption/decryption operations in a first plurality of stages of the series of stages, each of the stages of the first plurality of stages comprising a round, and repeating this operation for a selected number of times and for a selected number of rounds each of the selected number of times, to thereby effect a total number of rounds.

78. The method of claim 76 further comprising:
performing in series the stages of the encryption/decryption operations in a first plurality of stages of the series of stages, each of the stages of the first plurality of stages comprising a round, and repeating this operation for a selected number of times and for a selected number of rounds each of the selected number of times, to thereby effect a total number of rounds.

79. The method of claim 77 further comprising:
performing in any given one of the first plurality of times less than the first plurality of rounds depending upon the total number of rounds necessary.

80. The method of claim 78 further comprising:
performing in any given one of the first plurality of times less than the first plurality of rounds depending upon the total number of rounds necessary.

81. The apparatus of claim 75 further comprising:
providing a round encryption or decryption key of the first selected width for combination with the block data of the first selected width, based upon an initial encryption or decryption key of a second selected width.

82. The method of claim 76 further comprising:
providing a round encryption or decryption key of the first selected width for combination with the block data of the first selected width, based upon an initial encryption or decryption key of a second selected width.

83. The method of claim 77 further comprising:
providing a round encryption or decryption key of the first selected width for combination with the block data of the first selected width, based upon an initial encryption or decryption key of a second selected width.

84. The method of claim 78 further comprising:
providing a round encryption or decryption key of the first selected width for combination with the block data of the first selected width, based upon an initial encryption or decryption key of a second selected width.

85. The method of claim 79 further comprising:
providing a round encryption or decryption key of the first selected width for combination with the block data of the first selected width, based upon an initial encryption or decryption key of a second selected width.

86. The method of claim 80 further comprising:
providing a round encryption or decryption key of the first selected width for combination with the block data of the first selected width, based upon an initial encryption or decryption key of a second selected width.

87. The method of claim 81, further comprising:
generating each round key by the expansion of a starting key of a second selected width.

88. The method of claim 82, further comprising:
generating each round key by the expansion of a starting key of a second selected width.

89. The method of claim 83, further comprising:
generating each round key by the expansion of a starting key of a second selected width.

90. The method of claim 84, further comprising:
generating each round key by the expansion of a starting key of a second selected width.

91. The method of claim 85, further comprising:
generating each round key by the expansion of a starting key of a second selected width.

92. The method of claim 86, further comprising:
generating each round key by the expansion of a starting key of a second selected width.

93. The method of claim 87, further comprising:
the second selected width equals the first selected width.

94. The method of claim 88, further comprising:
the second selected width equals the first selected width.

95. The method of claim 89, further comprising:
the second selected width equals the first selected width.

96. The method of claim 90, further comprising:
the second selected width equals the first selected width.

97. The method of claim 91, further comprising:
the second selected width equals the first selected width.

98. The method of claim 92, further comprising:
the second selected width equals the first selected width.

99. The method of claim 93 further comprising:
the encryption step further includes performing an affine transformation and the decryption step further includes performing an inverse of the affine transformation.

100. The method of claim 94 further comprising:
the encryption step further includes performing an affine transformation and the decryption step further includes performing an inverse of the affine transformation.

101. The method of claim 95 further comprising:
the encryption step further includes performing an affine transformation and the decryption step further includes performing an inverse of the affine transformation.

102. The method of claim 96 further comprising:
the encryption step further includes performing an affine transformation and the decryption step further includes performing an inverse of the affine transformation.

103. The method of claim 97 further comprising:
the encryption step further includes performing an affine transformation and the decryption step further includes performing an inverse of the affine transformation.

104. The method of claim 98 further comprising:
the encryption step further includes performing an affine transformation and the decryption step further includes performing an inverse of the affine transformation.

105. An encryption/decryption method comprising:
performing in series stages of encryption/decryption operations on a stage data block of a first selected width utilizing an encryption/decryption key of the first selected width and providing an output data block of the first selected width, comprising a subsequent stage input data block input to a subsequent stage of the series of stages;
holding the stage input data block for input into a stage of the series of stages, the input data block having the first selected width;
encrypting the stage input data block into a encrypted stage input data block having the first selected width, the encrypted stage input data block comprising a unique combination of data bits for each unique combination of data bits in the stage input data block of the first selected width;
decrypting the stage input data block into a decrypted stage input data block having the first selected width, the decrypted stage input data block comprising a unique combination of data bits for each unique combination of data bits in the stage input data block of the first selected width that is the inverse of the encryption performed by the encryption step;
performing a substitution operation on either the encrypted stage input data block or the decrypted stage input data block; and,
selecting as a subsequent stage input data block for the subsequent stage of the series of stages the output of the substitution step or the stage input data block.

106. An encryption/decryption method comprising:
performing in series stages of encryption/decryption operations on a stage data block of a first selected width utilizing an encryption/decryption key of the first selected width and providing an output data block of the first selected width, comprising a subsequent stage input data block input to a subsequent stage of the series of stages;
holding the stage input data block for input into a stage of the series of stages, the input data block having the first selected width;
encrypting the stage input data block into a encrypted stage input data block having the first selected width, the encrypted stage input data block comprising a unique combination of data bits for each unique combination of data bits in the stage input data block of the first selected width;
decrypting the stage input data block into a decrypted stage input data block having the first selected width, the decrypted stage input data block comprising a unique combination of data bits for each unique combination of data bits in the stage input data block of the first selected width that is the inverse of the encryption performed by the encryption step;
performing a substitution operation on either the encrypted stage input data block or the decrypted stage input data block;
selecting as a subsequent stage input data block for the subsequent stage of the series of stages the output of the substitution step or the stage input data block; and,
performing in series the stages of the encryption/decryption operations in a first plurality of stages of the series of stages, each of the stages of the first plurality of stages comprising a round, and repeating this operation for a selected number of times and for a selected number of rounds each of the selected number of times, to thereby effect a total number of rounds.

107. An encryption/decryption method comprising:
performing in series stages of encryption/decryption operations on a stage data block of a first selected width utilizing an encryption/decryption key of the first selected width and providing an output data block of the first selected width, comprising a subsequent stage input data block input to a subsequent stage of the series of stages;
holding the stage input data block for input into a stage of the series of stages, the input data block having the first selected width;
encrypting the stage input data block into a encrypted stage input data block having the first selected width, the encrypted stage input data block comprising a unique combination of data bits for each unique combination of data bits in the stage input data block of the first selected width;
decrypting the stage input data block into a decrypted stage input data block having the first selected width, the decrypted stage input data block comprising a unique combination of data bits for each unique combination of data bits in the stage input data block of the first selected width that is the inverse of the encryption performed by the encryption step;
performing a substitution operation on either the encrypted stage input data block or the decrypted stage input data block;
selecting as a subsequent stage input data block for the subsequent stage of the series of stages the output of the substitution step or the stage input data block;
performing in series the stages of the encryption/decryption operations in a first plurality of stages of the series of stages, each of the stages of the first plurality of stages comprising a round, and repeating this operation for a selected number of times and for a selected number of rounds each of the selected number of times, to thereby effect a total number of rounds; and,
performing in any given one of the first plurality of times less than the first plurality of rounds depending upon the total number of rounds necessary.

108. An encryption/decryption method comprising:
performing in series stages of encryption/decryption operations on a stage data block of a first selected width utilizing an encryption/decryption key of the first selected width and providing an output data block of the first selected width, comprising a subsequent stage input data block input to a subsequent stage of the series of stages;
holding the stage input data block for input into a stage of the series of stages, the input data block having the first selected width;
encrypting the stage input data block into a encrypted stage input data block having the first selected width, the encrypted stage input data block comprising a unique combination of data bits for each unique combination of data bits in the stage input data block of the first selected width;
decrypting the stage input data block into a decrypted stage input data block having the first selected width, the decrypted stage input data block comprising a unique combination of data bits for each unique combination of data bits in the stage input data block of the first selected width that is the inverse of the encryption performed by the encryption step;
performing a substitution operation on either the encrypted stage input data block or the decrypted stage input data block;
selecting as a subsequent stage input data block for the subsequent stage of the series of stages the output of the substitution step or the stage input data block;
performing in series the stages of the encryption/decryption operations in a first plurality of stages of the series of stages, each of the stages of the first plurality of stages comprising a round, and repeating this operation for a selected number of times and for a selected number of rounds each of the selected number of times, to thereby effect a total number of rounds;
performing in any given one of the first plurality of times less than the first plurality of rounds depending upon the total number of rounds necessary; and,
generating each round key by the expansion of a starting key of a second selected width.

109. An encryption/decryption method comprising:
performing in series stages of encryption/decryption operations on a stage data block of a first selected width utilizing an encryption/decryption key of the first selected width and providing an output data block of the first selected width, comprising a subsequent stage input data block input to a subsequent stage of the series of stages;
holding the stage input data block for input into a stage of the series of stages, the input data block having the first selected width;
encrypting the stage input data block into a encrypted stage input data block having the first selected width, the encrypted stage input data block comprising a unique combination of data bits for each unique combination of data bits in the stage input data block of the first selected width;
decrypting the stage input data block into a decrypted stage input data block having the first selected width, the decrypted stage input data block comprising a unique combination of data bits for each unique combination of data bits in the stage input data block of the first selected width that is the inverse of the encryption performed by the encryption step;
performing a substitution operation on either the encrypted stage input data block or the decrypted stage input data block;
selecting as a subsequent stage input data block for the subsequent stage of the series of stages the output of the substitution step or the stage input data block;
performing in series the stages of the encryption/decryption operations in a first plurality of stages of the series of stages, each of the stages of the first plurality of stages comprising a round, and repeating this operation for a selected number of times and for a selected number of rounds each of the selected number of times, to thereby effect a total number of rounds;
performing in any given one of the first plurality of times less than the first plurality of rounds depending upon the total number of rounds necessary;
generating each round key by the expansion of a starting key of a second selected width; and,
the second selected width equals the first selected width.

110. An encryption/decryption method comprising:
performing in series stages of encryption/decryption operations on a stage data block of a first selected width utilizing an encryption/decryption key of the first selected width and providing an output data block of the first selected width, comprising a subsequent stage input data block input to a subsequent stage of the series of stages;
holding the stage input data block for input into a stage of the series of stages, the input data block having the first selected width;
encrypting the stage input data block into a encrypted stage input data block having the first selected width, the encrypted stage input data block comprising a unique combination of data bits for each unique combination of data bits in the stage input data block of the first selected width;
decrypting the stage input data block into a decrypted stage input data block having the first selected width, the decrypted stage input data block comprising a unique combination of data bits for each unique combination of data bits in the stage input data block of the first selected width that is the inverse of the encryption performed by the encryption step;
performing a substitution operation on either the encrypted stage input data block or the decrypted stage input data block;
selecting as a subsequent stage input data block for the subsequent stage of the series of stages the output of the substitution step or the stage input data block;
performing in series the stages of the encryption/decryption operations in a first plurality of stages of the series of stages, each of the stages of the first plurality of stages comprising a round, and repeating this operation for a selected number of times and for a selected number of rounds each of the selected number of times, to thereby effect a total number of rounds;
performing in any given one of the first plurality of times less than the first plurality of rounds depending upon the total number of rounds necessary;
generating each round key by the expansion of a starting key of a second selected width;
the second selected width equals the first selected width; and,
the encryption step further includes performing an affine transformation and the decryption step further includes performing an inverse of the affine transformation.
